(19) United States
(12) Patent Application Publication
(10) Pub. No.: US 2024/0223346 A1
(43) Pub. Date: Jul. 4, 2024

(54) COMMUNICATION USING TIME DIVISION DUPLEX PATTERN

(71) Applicant: KABUSHIKI KAISHA YASKAWA DENKI, Kitakyushu-shi (JP)

(72) Inventors: Ryota MORIWAKA, Fukuoka (JP); Kazuo FUJINO, Fukuoka (JP); Kazutoshi KOBAYASHI, Fukuoka (JP); Tadasuke YUBA, Fukuoka (JP); Yuki MINAMIDA, Fukuoka (JP); Ryo SHIMODOME, Fukuoka (JP); Jiro MURAOKA, Fukuoka (JP)

(21) Appl. No.: 18/604,525

(22) Filed: Mar. 14, 2024

Related U.S. Application Data
(63) Continuation of application No. PCT/JP2021/036851, filed on Oct. 5, 2021.
(63) Continuation of application No. PCT/JP2021/036838, filed on Oct. 5, 2021.
(63) Continuation of application No. PCT/JP2021/036849, filed on Oct. 5, 2021.

(51) Int. Cl. H04L 5/14; H04W 56/00

(52) U.S. Cl. CPC H04L 5/1469; H04W 56/001

(57) ABSTRACT

A communication system configured to perform wireless communication by repeating a time division duplex pattern having sequential arrangement of communication slots, the communication system including a pair of devices configured to: perform cyclic communication with each other by repeating a communication cycle using the wireless communication; and control the cyclic communication so that a first part of one time division duplex pattern of the wireless communication is included in one communication cycle of the cyclic communication and a second part of the one time division duplex pattern is included in another communication cycle of the cyclic communication subsequent to the one communication cycle.

### CROSS-REFERENCE TO RELATED APPLICATIONS

This application is a continuation application of PCT Application No. PCT/JP2021/036851, filed on Oct. 5, 2021. Additionally, the present application is a continuation application of PCT Application No. PCT/JP2021/036838, filed on Oct. 5, 2021. Additionally, the present application is a continuation application of PCT Application No. PCT/JP2021/036849, filed on Oct. 5, 2021. The entire contents of the above listed PCT and priority applications are incorporated herein by reference.

### BACKGROUND

### Field

The present disclosure relates to a communication system, communication control circuitry, and a communication method.

### Description of the Related Art

Japanese Unexamined Patent Publication No. 2019-209454 discloses a system including: a robot; a machining device; a robot controller that controls the robot; a machining device controller that controls the machining device; and a programmable logic controller that generates commands for the robot controller and the machining device controller.

### SUMMARY

Disclosed herein is a communication system configured to perform wireless communication by repeating a time division duplex pattern having sequential arrangement of communication slots. The communication system may include a pair of devices configured to: perform cyclic communication with each other by repeating a communication cycle using the wireless communication; and control the cyclic communication so that a first part of one time division duplex pattern of the wireless communication is included in one communication cycle of the cyclic communication and a second part of the one time division duplex pattern is included in another communication cycle of the cyclic communication subsequent to the one communication cycle.

Additionally, a circuitry configured to control cyclic communication performed by repeating a communication cycle using a wireless communication is disclosed herein. The wireless communication may be performed by repeating a time division duplex pattern having a sequential arrangement of communication slots. The circuitry may be configured to control the cyclic communication so that a first part of one time division duplex pattern is included in one communication cycle of the cyclic communication and a second part of the one time division duplex pattern is included in another communication cycle of the cyclic communication subsequent to the one communication cycle.

Additionally, a communication method is disclosed herein. The method may include: performing cyclic communication between a pair of devices by repeating a communication cycle using a wireless communication, wherein the wireless communication is performed by repeating a time division duplex pattern having sequentially arranged communication slots; and controlling the cyclic communication so that a first part of one time division duplex pattern is included in one communication cycle of the cyclic communication and a second part of the one time division duplex pattern is included in another communication cycle of the cyclic communication subsequent to the one communication cycle.

### BRIEF DESCRIPTION OF THE DRAWINGS

FIG. 1 is a schematic diagram illustrating an example configuration of a device system.

FIG. 2 is a schematic diagram illustrating an example configuration of a robot.

FIG. 3 is a block diagram illustrating an example configuration of a control server and a base station.

FIG. 4 is a table illustrating example storage contents of a pattern storage unit.

FIG. 5 is a schematic diagram illustrating an example time division duplex pattern.

FIGS. 6A, 6B, and 6C are diagrams illustrating an example relationship between a time division duplex pattern and communication cycles.

FIGS. 7A, 7B, and 7C are diagrams illustrating an example relationship between a time division duplex pattern and communication cycles.

FIG. 8 is a schematic diagram illustrating an example relationship between a target arrangement and an arrangement of communication slots in each communication cycle.

FIG. 9 is a block diagram illustrating an example configuration of a local controller and a mobile station.

FIG. 10 is a block diagram illustrating an example hardware configuration of a control server and a base station.

FIG. 11 is a block diagram illustrating an example hardware configuration of a local controller and a mobile station.

FIG. 12 is a flowchart illustrating an example procedure for setting a time division duplex pattern and a cycle start slot.

FIG. 13 is a flowchart illustrating an example wireless communication procedure.

FIG. 14 is a flowchart illustrating an example wireless communication procedure.

FIG. 15 is a flowchart illustrating an example communication control procedure.

FIG. 16 is a flowchart illustrating an example switching procedure of the communication mode.

FIG. 17 is a flowchart illustrating an example wireless communication procedure.

FIG. 18 is a flowchart illustrating an example wireless communication procedure.

FIG. 19 is a flowchart illustrating an example communication control procedure.

FIG. 20 is a flowchart illustrating an example switching procedure of the communication mode.

### DETAILED DESCRIPTION

In the following description, with reference to the drawings, the same reference numbers are assigned to the same components or to similar components having the same function, and overlapping description is omitted.

### Communication System

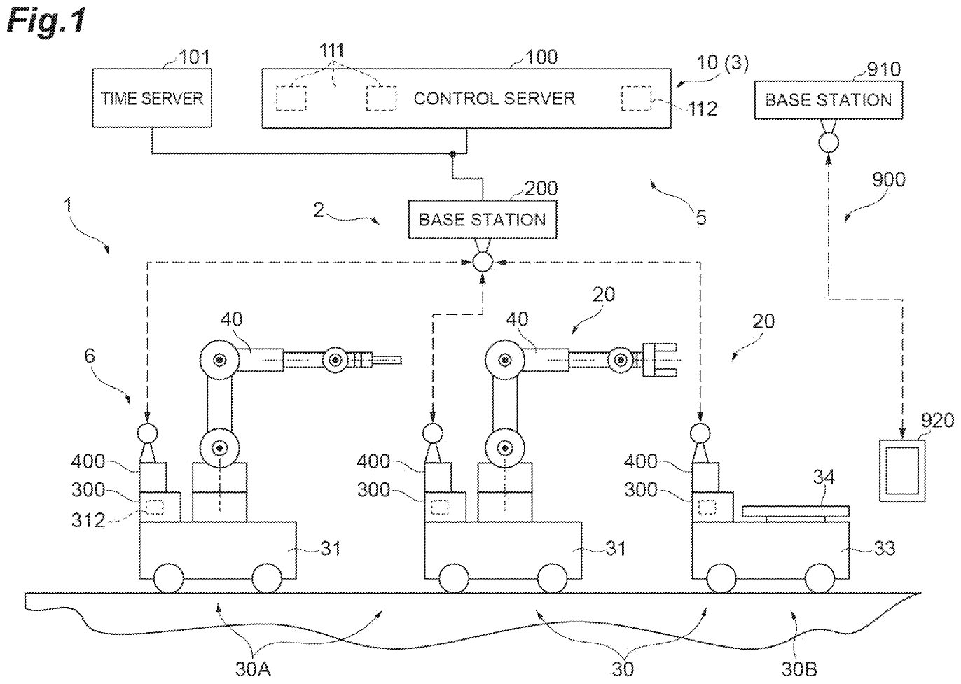

A communication system 1 illustrated in FIG. 1 is a system for performing wireless communication by time division duplex. The communication system 1 includes a wireless communication system 2 and an application 3. The wireless communication system 2 performs wireless communication by repeating a time division duplex pattern in which a plurality of communication slots are arranged in a time division manner. Arranging in a time division manner means arranging along a time base representing the passage of time.

The time division duplex is a wireless communication system that enables transmission and reception in the same frequency band by switching between transmission and reception from moment to moment. The wireless communication system 2 performs wireless communication by a 5G network as an example of wireless communication by time division duplex. For example, the wireless communication system 2 performs wireless communication by local 5G. The local 5G is a 5G network constructed for a limited area as compared with a public 5G in which a communication carrier provides communication service over a wide area.

The wireless communication system 2 includes a base station 200 and one or more mobile stations 400. For example, the wireless communication system 2 includes a plurality of mobile station 400. The base station 200 is installed in a target area of a local 5G and performs wireless communication with the plurality of mobile stations 400. Each of the plurality of mobile stations 400 is movable within the target area and performs wireless communication with the base station 200.

The plurality of communication slots in wireless communication include an uplink slot of time division duplex. The plurality of communication slots may further include a downlink slot of time division duplex. The uplink slot is a slot in which the mobile station 400 transmits data to the base station 200 (the base station 200 receives data from the mobile station 400). The downlink slot is a slot in which the base station 200 transmits data to the mobile station 400 (the mobile station 400 receives data from the base station 200).

The application 3 performs cyclic communication using the wireless communication system 2. The cyclic communication is communication in which data transmission and reception of the same contents are repeated. The application 3 may perform cyclic communication of a certain communication cycle (communication interval) using the wireless communication system 2. The application 3 may repeat a communication cycle that includes generating transmission data based on the reception data received by the base station 200 from the mobile station 400 and transmitting the transmission data from the base station 200 to the mobile station 400. The application 3 may repeat a communication cycle that includes generating transmission data based on the reception data received by the mobile station 400 from the base station 200 and transmitting the transmission data from the mobile station 400 to the base station 200.

“Application” represents an application target of wireless communication by the wireless communication system 2. Examples of the application 3 include a device system 10 including a plurality of devices. If the application 3 is the device system 10, the communication system 1 performs wireless communication in the device system 10. Each of the plurality of devices may be a hardware device configured by a set of hardware or may be a software device implemented in a computer by software.

As an example, the device system 10 includes a plurality of machines 20, a control server 100, and a time server 101. The machine 20 is an example of hardware devices. For example, the machine 20 is an industrial machine. Examples of the industrial machine include a machine tool, a transport device, and a robot. A servo system including a servo motor and servo drive circuitry is also an example of an industrial machine.

The machine 20 includes a machine body 30 and a local controller 300. The machine body 30 is a machine that provides motion. The local controller 300 controls the machine body 30 to provide the motion.

Although the type of the machine body 30 is not particularly limited, two types of machine bodies 30A, 30B are illustrated in FIG. 1. The machine body 30A is a movable robot that performs operations on a workpiece while moving. For example, the machine body 30A includes an automated guided vehicle 31 and a robot 40. The automated guided vehicle 31 moves by being driven by the local controller 300.

The robot 40 is installed on the automated guided vehicle 31. The robot 40 is driven by the local controller 300 to perform operations such as conveyance, machining, and assembly on the workpiece.

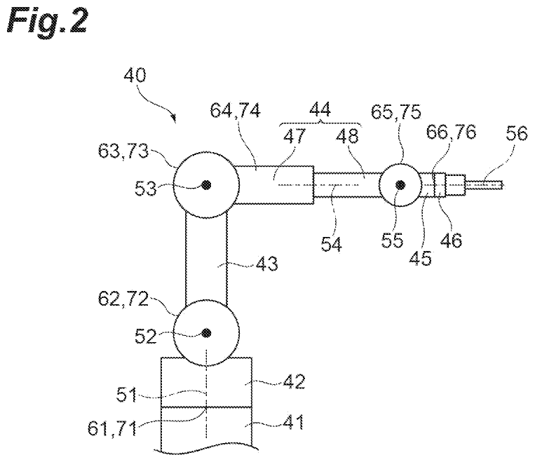

The robot 40 is, for example, a vertical articulated industrial robot. As illustrated in FIG. 2, the robot 40 includes a base 41, a pivoting portion 42, a first arm 43, a second arm 44, a wrist portion 45, and a tip portion 46. The base 41 is installed on the automated guided vehicle 31. The pivoting portion 42 is mounted on the base 41 so as to be rotatable about a vertical axis 51. For example, the robot 40 includes a joint 61 that attaches the pivoting portion 42 to the base 41 so as to be rotatable about the axis 51. The first arm 43 is connected to the pivoting portion 42 so as to be rotatable about an axis 52 that intersects (for example, is orthogonal to) the axis 51. For example, the robot 40 has a joint 62 that connects the first arm 43 to the pivoting portion 42 so that it is rotatable about the axis 52. The intersection includes being in a twisted relationship like so-called three-dimensional intersection. The same applies to the following description. The first arm 43 extends from the pivoting portion 42 along a direction that intersects (for example, is orthogonal to) the axis 52.

The second arm 44 is connected to the end of the first arm 43 so as to be rotatable about an axis 53 that is parallel to the axis 52. For example, the robot 40 includes a joint 63 that connects the second arm 44 to the first arm 43 so as to be rotatable about the axis 53. The second arm 44 includes an arm base 47 extending from an end of the first arm 43 along one direction that intersects (for example, is orthogonal to) the axis 53 and an arm end 48 further extending from an end of the arm base 47 along the same direction. The arm end 48 is rotatable about an axis 54 relative to the arm base 47. The axis 54 intersects (for example, is orthogonal to) the axis 53. For example, the robot 40 includes a joint 64 that connects the arm end 48 to the arm base 47 so as to be rotatable about the axis 54.

The wrist portion 45 is connected to the end of the arm end 48 so as to be rotatable about an axis 55 that intersects (for example, is orthogonal to) the axis 54. For example, the robot 40 includes a joint 65 that connects the wrist portion 45 to the arm end 48 so as to be rotatable about the axis 55. The wrist portion 45 extends from an end of the arm end 48 along a direction that intersects (for example, is orthogonal to) the axis 55. The tip portion 46 is connected to the end of the wrist portion 45 so as to be rotatable about an axis 56 that intersects (for example, is orthogonal to) the axis 55. For example, the robot 40 includes a joint 66 that connects the tip portion 46 to the wrist portion 45 so as to be rotatable about the axis 56. The tip portion 46 is provided with an end effector. Examples of the end effector include a hand that grips a workpiece and a work tool that performs processing, assembly, and the like on a workpiece.

Actuators 71, 72, 73, 74, 75, 76, drive the joints 61, 62, 63, 64, 65, 66. Each of the actuators 71, 72, 73, 74, 75, 76 includes, for example, an electric motor and a transmission unit (for example, a speed reducer) that transmits power of the electric motor to the joints 61, 62, 63, 64, 65, 66. For example, the actuator 71 drives the joint 61 to rotate the pivoting portion 42 about the axis 51. The actuator 72 drives the joint 62 to rotate the first arm 43 about the axis 52. The actuator 73 drives the joint 63 to rotate the second arm 44 about the axis 53. The actuator 74 drives the joint 64 to rotate the arm end 48 about the axis 54. The actuator 75 drives the joint 65 to rotate the wrist portion 45 about the axis 55. The actuator 76 drives the joint 66 to rotate the tip portion 46 about the axis 56.

Returning to FIG. 1, the machine body 30B is an automated guided vehicle that conveys an object to be conveyed such as a workpiece. The machine body 30B includes an automated guided vehicle 33 and a loading table 34. The automated guided vehicle 33 moves by being driven by the local controller 300. The loading table 34 is provided on the automated guided vehicle 33 and supports a conveyance object.

The control server 100 includes a plurality of controllers 111 each controlling the plurality of machines 20. Each of the plurality of controllers 111 is an example of software devices and is implemented in the control server 100 by software. The plurality of controllers 111 may be hardware devices independent from each other in hardware.

The communication system 1 communicates from the controller 111 to the machine 20 by downlink slot and from the machine 20 to the controller 111 by uplink slot. For example, the base station 200 of the wireless communication system 2 is connected to the control server 100 via a wired communication network. A plurality of mobile stations 400 of the wireless communication system 2 are provided in the plurality of machines 20, respectively, and connected to a plurality of local controllers 300, respectively. The control server 100 transmits data to each of the plurality of machines 20 via the base station 200 and the mobile station 400, and receives data from each of the plurality of machines 20 via the mobile station 400 and the base station 200. Each of the plurality of local controllers 300 transmits data to the control server 100 via the mobile station 400 and the base station 200 and receives data from the control server 100 via the base station 200 and the mobile station 400.

The application 3 uses the wireless communication system 2 to transmit and receive control data for controlling the machine 20. Examples of the control data include command data for controlling the machine 20 and response data of the industrial machine corresponding to the command data.

The command data is, for example, data representing an operation command for the machine 20. Examples of the data representing an operation command include a target operation data representing a target operation of the machine 20. The target data includes a target position, a target speed, or the like with respect to the machine 20. The data representing the operation command may be a target output data representing a target output (for example, a target torque or a target current) for causing the operation of the machine 20 to follow the target operation. The response data is, for example, a data representing an operation achieved by the machine 20 in accordance with the command data. Examples of the data representing the operation include an operation speed of the machine 20, a position of the machine 20, and the like.

For example, the application 3 repeatedly a communication cycle including transmission of command data from the controller 111 to the machine 20 and transmission of response data from the machine 20 to the controller 111 by cyclic communication. Thus, the controller 111 repeatedly executes a communication cycle including transmission of command data and reception of response data by cyclic communication. The machine 20 repeatedly executes a communication cycle including reception of command data and transmission of response data by cyclic communication.

The time server 101 is a computer connected to the control server 100 via a wired communication network and generates a global time. The time server 101 may be incorporated into the control server 100 or may be incorporated into the base station 200. The global time is used to match at least the time inside the control server 100 and the time inside the base station 200 to the global time.

Communication control units 112, 312 control cyclic communication. For example, the communication control unit 112 controls communication through downlink slots in cyclic communication. The communication control unit 112 and the base station 200 constitute a wireless communication device 5 that communicates from the controller 111 to the machine 20 through downlink slots. The communication control unit 312 controls communication through uplink slots in cyclic communication. The communication control unit 312 and the mobile station 400 constitute a wireless communication device 6 that communicates from the machine 20 to the controller 111 through an uplink slot.

As an example, the communication control unit 112 is incorporated into the control server 100 and the communication control unit 312 is incorporated into the local controller 300. As described above, if a plurality of controllers 111 are hardware devices independent from each other, the communication control unit 112 may be incorporated in each of the plurality of controllers 111. The communication control unit 112 may be incorporated into the base station 200 and the communication control unit 312 may be incorporated into the mobile station 400.

In wireless communication performed in the device system 10, timing at which information is to be transmitted through a downlink slot and timing at which information is to be transmitted through an uplink slot may be changed depending on a configuration of the device system 10. Thus, the communication system 1 may be configured to perform: obtaining configuration information representing the configuration of the device system 10; setting a time division duplex pattern that defines an arrangement of a downlink slot of time division duplex and an uplink slot of the time division duplex in accordance with a configuration of the device system 10; and performing wireless communication by repeating the set time division duplex pattern. With this configuration, the time division duplex pattern is set in accordance with the configuration of the device system, and wireless communication is performed by repeating the set time division duplex pattern. Accordingly, wireless communication may timely be performed.

When the time division duplex pattern is repeated, reliability of communication of a plurality of communication slots may be different from each other depending on a position in the time division duplex pattern. For example, via a space that at least partially overlaps the space in which the wireless communication system 2 performs the wireless communication, another wireless communication system 900 may perform another wireless communication. The other wireless communication system 900 performs the other wireless communication by repeating another time division duplex pattern in which a plurality of other communication slots are arranged in a time division manner. Examples of the other wireless communication system 900 include a system in which wireless communication is performed by the above-described public 5G.

For example, the other wireless communication system 900 includes a base station 910 and a terminal 920. The terminal 920 is, for example, a mobile communication terminal such as a smartphone, tablet computer, laptop computer, or the like. The base station 910 is installed at the end of the communication network of a communication carrier, performs wireless communication with the terminal 920, and relays communication between the communication network and the terminal 920.

When the other wireless communication system 900 performs the other wireless communication by repeating the other time division duplex pattern, a plurality of communication slots of the time division duplex pattern repeated by the wireless communication system 2 may include a synchronous slot and an asynchronous slot. The synchronous slot is a communication slot that matches a communication slot of the other wireless communication performed at the same timing in terms of whether being the downlink slot or the uplink slot. The asynchronous slot is a communication slot that does not match a communication slot of the other wireless communication performed at the same timing in terms of whether being the downlink slot or the uplink slot. Compared to the communication through the synchronous slot, in the communication through the asynchronous slot, a degradation in communication quality is likely to occur due to interference with communication through a communication slot of the other wireless communication.

In this manner, the plurality of communication slots may include a first type of communication slot (for example, a synchronous slot) and a second type of communication slot (for example, an asynchronous slot) in which communication reliability is different from each other. Accordingly, the wireless communication device 5 may be configured to perform: transmitting transmission data from the base station 200 (a wireless communication unit) to the mobile station 400 (a counterpart wireless communication unit) through a first type of communication slot if the transmission data generated by the controller 111 has a first attribute; and transmitting transmission data from the base station 200 (a wireless communication unit) to the mobile station 400 (a counterpart wireless communication unit) through a second type of communication slot if the transmission data has a second attribute.

Similarly, the wireless communication device 6 may be configured to perform: transmitting transmission data from the mobile station 400 (a wireless communication unit) to the base station 200 (a counterpart wireless communication unit) through a first type of communication slot if the transmission data generated by the machine 20 has a first attribute; and transmitting transmission data from the mobile station 400 (a wireless communication unit) to the base station 200 (a counterpart wireless communication unit) through a second type of communication slot if the transmission data has a second attribute.

The time division duplex pattern may not be suitable for cyclic communication of an application. Accordingly, the communication system 1 may be configured to perform: performing the cyclic communication using the wireless communication system 2; and controlling the cyclic communication so that at least a part of each of two or more consecutive communication cycles of the cyclic communication is performed within one time division duplex pattern of the wireless communication. With this configuration, the arrangement of communication slots in each communication cycle of cyclic communication (hereinafter referred to as a “slot arrangement”) may be adjusted without changing the time division duplex pattern. Accordingly, wireless communication may readily be applied to various applications.

Hereinafter, example configurations of the control server 100, the base station 200, the local controller 300, and the mobile station 400 will be described in more detail.

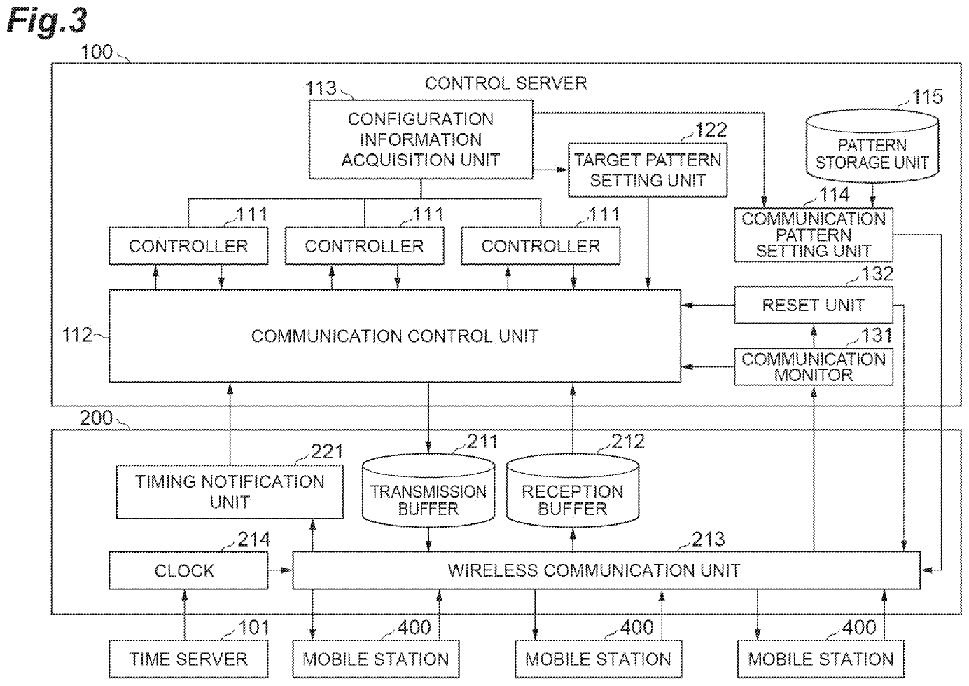

Configuration of Control Server and Base Station FIG. 3 is a block diagram illustrating an example configuration of the control server 100 and the base station 200. As illustrated in FIG. 3, the control server 100 includes a plurality of controllers 111 and the communication control unit 112 as functional components (hereinafter referred to as “functional blocks”). Each of the plurality of controllers 111 (hereinafter simply referred to as a “controller 111”) controls a corresponding machine 20.

The controller 111 controls the machine 20 by repeating a control cycle that includes one or more communications from the controller 111 to the machine 20 and one or more communications from the machine 20 to the controller 111. For example, the controller 111 repeats a control cycle including reception of the response data from the machine 20, generation of the command data based on the response data, and transmission of the command data to the machine 20. For example, the controller 111 calculates, as the command data, the target output data for causing the operation of the machine 20 represented by the response data to follow the target operation. For example, the controller 111 calculates the target output data by performing a proportional operation, a proportional-integral operation, a proportional-integral-derivative operation, or the like on the deviation between the target operation and the operation of the machine 20.

The controller 111 repeats a constant control cycle (control interval). For example, the controller 111 performs a control cycle each time a control clock signal is generated that indicates the elapse of a certain control cycle. In this example, the process performed by the controller 111 from the generation of the control clock signal to the generation of the next control clock signal is one control cycle.

In each control cycle, the controller 111 may perform reception of response data after generation of command data and transmission of the command data. In this example, the controller 111 generates command data based on response data received in the immediately preceding control cycle.

In each control cycle, the controller 111 may perform reception of response data and generation of command data after transmission of command data. In this example, the controller 111 transmits the command data generated in the immediately preceding control cycle.

The control cycle includes a communication cycle. The communication cycle includes transmission of command data and reception of response data. If the controller 111 performs the control cycle every time the control clock signal is generated, the processing performed by the controller 111 from the generation of the control clock signal to the generation of the next control clock signal is one communication cycle.

The controller 111 causes the communication control unit 112 to perform reception of reception data such as response data and transmission of transmission data such as command data. For example, the controller 111 causes the communication control unit 112 to receive the reception data, and acquires the reception data received by the communication control unit 112. Further, the controller 111 outputs transmission data to the communication control unit 112 and causes the communication control unit 112 to transmit the transmission data.

The communication control unit 112 performs reception of the reception data and transmission of the transmission data via the base station 200. The base station 200 includes a transmission buffer 211, a reception buffer 212, a wireless communication unit 213, and a clock 214. The wireless communication unit 213 performs wireless communication with the mobile station 400 (a counterpart wireless communication unit) by repeating the time division duplex pattern. For example, the wireless communication unit 213 reads the transmission data from the transmission buffer 211 and transmits the transmission data to the mobile station 400 through the downlink slot of the time division duplex pattern. Further, the wireless communication unit 213 receives reception data from the mobile station 400 through an uplink slot of the time division duplex pattern and stores the reception data in the reception buffer 212.

The communication control unit 112 is configured to transfer the transmission data from the controller 111 (first device) to the wireless communication system 2. For example, the communication control unit 112 stores the transmission data acquired from the controller 111 in the transmission buffer 211. As described above, the transmission data stored in the transmission buffer 211 is read by the wireless communication unit 213. Therefore, storing transmission data in the transmission buffer 211 is an example of delivering transmission data to the wireless communication unit 213. Data stored in the transmission buffer 211 is transmitted to the machine 20 via the base station 200 and the mobile station 400.

The communication control unit 112 reads, from the reception buffer 212, the reception data that the wireless communication unit 213 has received from the mobile station 400. Reading reception data from the reception buffer 212 is an example of acquiring reception data from the wireless communication unit 213. Reception data is received from the machine 20 via the mobile station 400 and the base station 200 by reading the reception data from the reception buffer 212.

The clock 214 repeatedly generates a time for repetition of the time division duplex pattern. Hereinafter, the time that the clock 214 generates is referred to as “base station time”. The wireless communication unit 213 repeats the time division duplex pattern based on the base station time.

For example, the wireless communication unit 213 performs a time division duplex pattern every time a communication clock signal indicating the elapse of a certain repetition cycle (repetition interval) is generated. In this example, communication performed from generation of a communication clock signal to generation of the next communication clock signal is one time division duplex pattern. The wireless communication unit 213 may perform the time division duplex pattern every time a repetition cycle elapses from a predetermined start time in the base station time. In this example, communication performed from a time obtained by adding an integral multiple of the repetition cycle to the start time to when one repetition cycle elapses is one time division duplex pattern.

The wireless communication unit 213 may repeat the time division duplex pattern in synchronization with another time division duplex pattern repeated by the other wireless communication system 900. In this example, the clock 214 may be configured to generate a base station time synchronized with the global time. For example, the clock 214 receives the global time from the time server 101 by communication that guarantees time synchronization, such as time sensitive networking (TSN) communication via a wired communication network, and generates the base station time in synchronization with the received global time. For example, the clock 214 synchronizes the base station time with the global time and then repeatedly updates the base station time by counting clock pulses of a predetermined cycle. The clock 214 may repeatedly perform synchronizing the base station time to the global time at a predetermined time interval.

Also in the other the wireless communication system 900, the other time division duplex pattern is repeated based on the time synchronized with the global time. The wireless communication unit 213 repeats a time division duplex pattern in synchronization with the other time division duplex pattern based on the base station time synchronized with the global time. For example, the wireless communication system 900 executes the other time division duplex pattern every time a repetition cycle elapses from a predetermined start time in a time synchronized with the global time. The wireless communication unit 213 also repeats the time division duplex pattern every time the repetition cycle elapses from the start time in the base station time synchronized with the global time. This causes the wireless communication unit 213 to start a time division duplex pattern at the same time that the other the wireless communication system 900 starts the other time division duplex pattern.

As described above, the communication system 1 may be configured to perform: acquiring configuration information representing the configuration of the device system 10; setting a time division duplex pattern that defines the arrangement of downlink slots of time division duplex and uplink slots of time division duplex in accordance with the configuration of the device system 10; and performing wireless communication by repeating the set time division duplex pattern. In this example, the control server 100 further includes a configuration information acquisition unit 113 and a communication pattern setting unit 114.

The configuration information acquisition unit 113 acquires configuration information representing the configuration of the device system 10. For example, the configuration information acquisition unit 113 acquires configuration information from a plurality of controllers 111.

The communication pattern setting unit 114 sets a time division duplex pattern that determines the arrangement of the downlink slots of the time division duplex and the uplink slots of the time division duplex in accordance with the configuration of the device system 10. The communication pattern setting unit 114 notifies the wireless communication unit 213 of the set time division duplex pattern. The wireless communication unit 213 performs the wireless communication by repeating the time division duplex pattern notified from the communication pattern setting unit 114.

For example, if the device system 10 is the first configuration, the communication pattern setting unit 114 sets the time division duplex pattern to a first pattern If the device system 10 is a second configuration different from the first configuration, the device system 10 sets the time division duplex pattern to a second pattern in which the arrangement of downlink slots and uplink slots is different from that of the first pattern.

The second configuration may be a configuration in which the amount of communication information from the plurality of machines 20 to the plurality of controllers 111 is greater than that in the first configuration. In this example, the communication pattern setting unit 114 may set the time division duplex pattern to the second pattern having a greater number of uplink slots than that of the first pattern if the device system 10 is the second configuration. The communication pattern setting unit 114 may set the time division duplex pattern to the second pattern in which the number of uplink slots is greater than the number of downlink slots if the device system 10 is the second configuration.

The configuration information may include communication configuration information indicating a relationship between an amount of communication from the plurality of controllers 111 to the plurality of machines 20 and an amount of communication from the plurality of machines 20 to the plurality of controllers 111. In this example, the communication pattern setting unit 114 may set the time division duplex pattern based on the communication configuration information.

The configuration may include a hardware configuration of the device system 10. For example, the first configuration may include a first hardware configuration, and the second configuration may include a second hardware configuration different from the first hardware configuration. Examples of the difference in hardware configurations include differences in type and number of the machines 20 included in the device system 10.

The configuration may include work content to be performed by the device system 10. For example, the first configuration may include causing the machine 20 to perform a first task and the second configuration may include causing the machine 20 to perform a second task that is different from the first task. Examples of the difference in tasks include differences in the type and the number of times of work achieved by operations of the machine 20.

The configuration information acquisition unit 113 may acquire the configuration information while the plurality of controllers 111 are controlling the plurality of machines 20. The communication pattern setting unit 114 may change the time division duplex pattern when the configuration information changes. Examples of the case where the configuration information changes include a case where a relationship between a communication amount per unit time from the plurality of controllers 111 to the plurality of machines 20 and a communication amount per unit time from the plurality of machines 20 to the plurality of controllers 111 changes due to a change in a task that the plurality of controllers 111 cause the plurality of machines 20 to execute.

The communication pattern setting unit 114 may select a time division duplex pattern corresponding to the configuration of the device system 10 based on a reference table defining the time division duplex pattern for each of the plurality of configurations. In this example, the selected time division duplex pattern becomes the result of the time division duplex pattern set by the communication pattern setting unit 114. For example, the control server 100 may further include a pattern storage unit 115 that stores a reference table. The communication pattern setting unit 114 selects a time division duplex pattern corresponding to the configuration of the device system 10 in the reference table stored by the pattern storage unit 115.

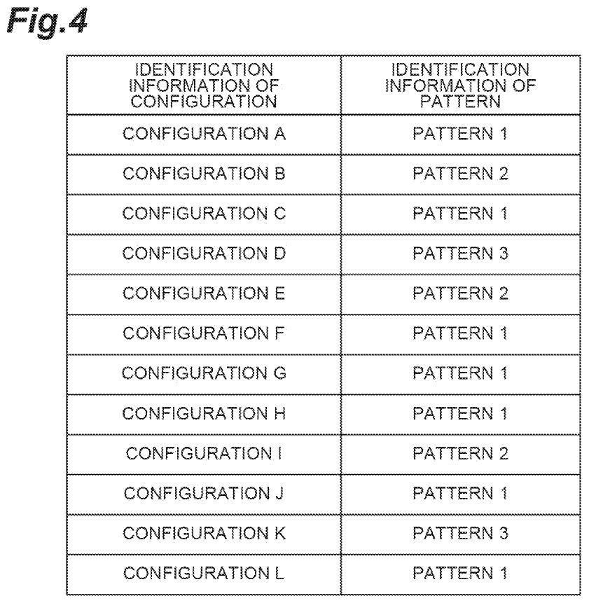

FIG. 4 illustrates an example reference table stored by the pattern storage unit 115. The reference table illustrated in FIG. 4 associates identification information of a plurality of configurations with identification information of a plurality of time division duplex patterns, respectively. If the configuration of the device system 10 is “CONFIGURATION E” in FIG. 4, the communication pattern setting unit 114 selects “PATTERN 2” that is associated with “CONFIGURATION E”.

The first pattern may correspond to the other time division duplex pattern repeated in the other wireless communication performed by the other wireless communication system 900. The second pattern may include a synchronous slot that matches a communication slot of the other time division duplex pattern in terms of whether being a downlink slot or an uplink slot, a synchronous slot that does not match the communication slot of the other time division duplex pattern in terms of whether being a downlink slot or an uplink slot, and an asynchronous slot.

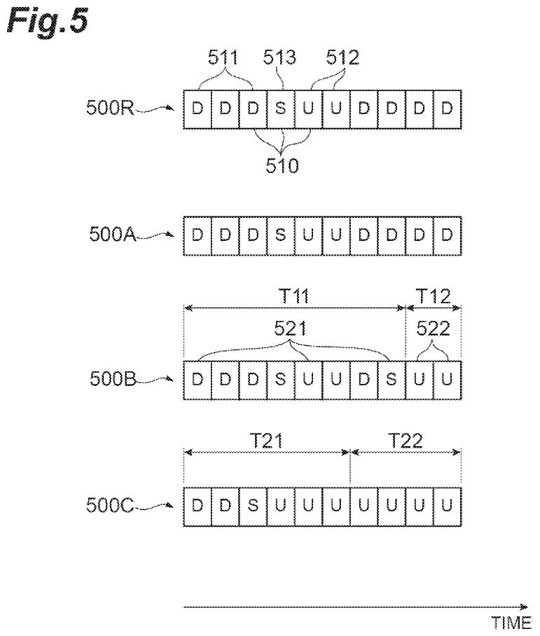

FIG. 5 is a schematic diagram illustrating a time division duplex pattern. A time division duplex pattern 500R represents the time division duplex pattern in the public 5G described above. In the time division duplex pattern 500R, three downlink slots 511 are arranged along the time base, then two uplink slots 512 are arranged along the time base, and then four downlink slots 511 are arranged along the time base. A special slot 513 is arranged between the three downlink slots 511 and the two uplink slots 512. The special slot 513 is a slot including a transmission section from the base station 200 to the mobile station 400, a non-transmission section, and a transmission section from the mobile station 400 to the base station 200 in this order. The special slot 513 can be used as the downlink slot 511 and can also be used as the uplink slot 512.

A time division duplex pattern 500A illustrates an example first pattern that matches the time division duplex pattern 500R. A time division duplex pattern 500B illustrates an example second pattern. In the time division duplex pattern 500B, three downlink slots 511 are arranged along the time base, then two uplink slots 512 are arranged along the time base, then one downlink slot 511 is arranged, and then two uplink slots 512 are arranged along the time base. The special slot 513 is arranged between the three downlink slots 511 and the following two uplink slots 512. The special slot 513 is also arranged between the one downlink slot 511 and the following two uplink slots 512.

In the time division duplex pattern 500B, from the first communication slot 510, which is the downlink slot 511, to the seventh communication slot 510, which is the downlink slot 511, correspond to synchronous slots 521. The eighth communication slot 510, which is the special slot 513, can also be used as the synchronous slot 521. The ninth and tenth communication slots 510, which are the uplink slots 512, correspond to asynchronous slots 522.

Accordingly, in the time division duplex pattern 500B, a period T11 in which the first to eighth the communication slot 510 are arranged is a synchronous period, and a period T12 in which the ninth and tenth the communication slot 510 are arranged is an asynchronous period.

A time division duplex pattern 500C represents another example of the second pattern. In the time division duplex pattern 500C, two downlink slots 511 are arranged along the time base, and then seven uplink slots 512 are arranged along the time base. The special slot 513 is arranged between the two downlink slots 511 and the following seven uplink slots 512. In the time division duplex pattern 500C, the first and second communication slots 510, which are the downlink slot 511, and the fifth and sixth communication slots 510, which are the uplink slots 512, correspond to the synchronous slots 521. The third communication slot 510, which is the special slot 513, can also be used as the synchronous slot 521. Furthermore, the fourth communication slot 510, which is the uplink slot 512, can also be used as the synchronous slot 521 because the communication slot 510 performed by the other wireless communication system 900 at the same timing is the special slot 513. The seventh to tenth communication slots 510, which are the uplink slots 512, correspond to the asynchronous slots 522.

Accordingly, in the time division duplex pattern 500C, a period T21 in which the first to sixth communication slots 510 are arranged is a synchronous period, and a period T22 in which the seventh to tenth communication slots 510 are arranged is an asynchronous period.

In the asynchronous slot 522, communication quality is more likely to be degraded due to interference with the communication slot 510 of the time division duplex pattern 500R than in the synchronous slot 521. Thus, the synchronous slot 521 is an example of a first type of communication slot 510 described above, and the asynchronous slot 522 is an example of a second type of communication slot 510 described above.

It should be noted that “first type” and “second type” are terms given for convenience in order to distinguish the communication slots 510. Therefore, the synchronous slot 521 may not be the first type of communication slot 510, and the asynchronous slot 522 may not be the second type of communication slot 510. The synchronous slot 521 may be the second type of communication slot 510 and the asynchronous slot 522 may be the first type of communication slot 510.

As the time division duplex pattern 500B or the time division duplex pattern 500C, when a time division duplex pattern includes a first type of communication slot and a second type of communication slot, the communication control unit 112 may cause transmission data generated by the controller 111 to be transmitted from the wireless communication unit 213 to the mobile station 400 through the first type of communication slot 510 when the transmission data has a first attribute and may cause transmission data to be transmitted by the second type of communication slot 510 from the wireless communication unit 213 to the mobile station 400 if the transmission data generated by the controller 111 has a second attribute.

The “attribute” represents a property of data that does not change regardless of the value of the data. Example of the attribute includes a type of the data. The type of the data is the type of an event represented by the value of the data. As an example of the event, data representing the “current position” is the data representing the “current position” even if the value representing the “current position” changes. If the priority of the data is determined in accordance with the type of the data, the priority is also an example of an attribute.

The first attribute may be a first priority. The second attribute may be a second priority lower than the first priority. The communication control unit 112 may control the wireless communication unit 213 so that transmission data having the first priority is transmitted to the mobile station 400 through the synchronous slot 521 and transmission data having the second priority is transmitted to the mobile station 400 through the asynchronous slot 522.

The first attribute may be “being the control data” and the communication control unit 112 may control the wireless communication unit 213 so that the transmission data is transmitted through the synchronous slot 521 if the transmission data is control data. The second attribute may be “being a data of a predetermined type different from that of the control data”, and the communication control unit 112 may control the wireless communication unit 213 so that transmission data is transmitted through the asynchronous slot 522 if the transmission data is the data of the predetermined type.

As described above, the communication control unit 112 controls which of the communication slots 510 is used to transmit the transmission data based on the attribute of the transmission data. In order to perform such control, the communication control unit 112 acquires attribute information representing an attribute of transmission data from the controller 111 together with the transmission data. The communication control unit 112 attaches a tag indicating the attribute of the transmission data to the transmission data based on the acquired attribute information, and stores the transmission data to which the tag is attached in the transmission buffer 211. The wireless communication unit 213 controls through which the communication slot 510 the transmission data is transmitted based on the tag attached to the transmission data.

For example, if the transmission data has the first attribute, the communication control unit 112 attaches a first tag to the transmission data and stores the transmission data in the transmission buffer 211. If the transmission data has the second attribute, the communication control unit 112 attaches a second tag and stores the transmission data in the transmission buffer 211. The wireless communication unit 213 transmits transmission data to the mobile station 400 through the first type of communication slot 510 if the first tag is attached to transmission data, and transmits transmission data to the mobile station 400 through the second type of communication slot 510 if the second tag is attached to transmission data.

The method for controlling, based on the attribute of the transmission data, through which of the communication slots 510 the transmission data is to be transmitted is not limited to the method of attaching a tag to the transmission data. For example, the communication control unit 112 may determine through which of the communication slots 510 transmission data is to be transmitted based on the attribute of the transmission data and may control the timing of storing the transmission data in the transmission buffer 211 so that the transmission data is transmitted through the determined communication slot 510.

In this example, the base station 200 further includes a timing notification unit 221. The timing notification unit 221 notifies the communication control unit 112 of the start timing of the time division duplex pattern. The communication control unit 112 recognizes the execution timing of each the communication slot 510 based on the start timing of the time division duplex pattern, and controls the timing for storing the transmission data in the transmission buffer 211 so that the transmission data is transmitted in the determined communication slot 510.

As described above, the time division duplex pattern may not be suitable for cyclic communication of the application 3. Accordingly, the communication system 1 may be configured to: perform the cyclic communication using the wireless communication system 2; and control the cyclic communication so that at least a part of each of two or more consecutive communication cycles of the cyclic communication is performed within one time division duplex pattern of the wireless communication.

In this example, the communication control unit 112 controls the cyclic communication so that at least a part of each of two or more consecutive communication cycles of the cyclic communication is performed within one time division duplex pattern of the wireless communication. For example, the communication control unit 112 controls the timing of writing transmission data in the transmission buffer 211 and the timing of reading reception data from the reception buffer 212 in each communication cycle so that at least a part of each of the two or more communication cycles is performed within one time division duplex pattern. For example, the communication control unit 112 controls timing of storing transmission data in the transmission buffer 211 in each communication cycle so that one communication cycle of two or more communication cycles is started in a predetermined communication slot 510 in the communication slots 510 arranged between the first communication slot 510 and the last communication slot 510 in a time division duplex pattern. Hereinafter, the predetermined communication slot 510 is referred to as a “cycle start slot”.

For example, the communication control unit 112 recognizes the execution timing of the cycle start slot based on the start timing of the time division duplex pattern acquired from the timing notification unit 221. The communication control unit 112 controls the timing of storing the transmission data in the transmission buffer 211 in each communication cycle so that the one communication cycle is started in the cycle start slot based on the timing of executing the cycle start slot.

As described above, the application 3 may perform the cyclic communication in a predetermined communication cycle. In this example, the application 3 may perform the cyclic communication in the same communication cycle as the repetition cycle of the time division duplex pattern. The “repetition cycle” is the time from the start timing of a time division duplex pattern to the start timing of the next time division duplex pattern. The “communication cycle” is the time from the start timing of a communication cycle to the start timing of the next communication cycle.

If the repetition cycle is equal to the communication cycle, the communication control unit 112 controls the cyclic communication so that all communication cycles are started in the cycle start slot. If the repetition cycle is equal to the communication cycle, each communication cycle started in the cycle start slot is performed over two or more consecutive time division duplex patterns of wireless communication.

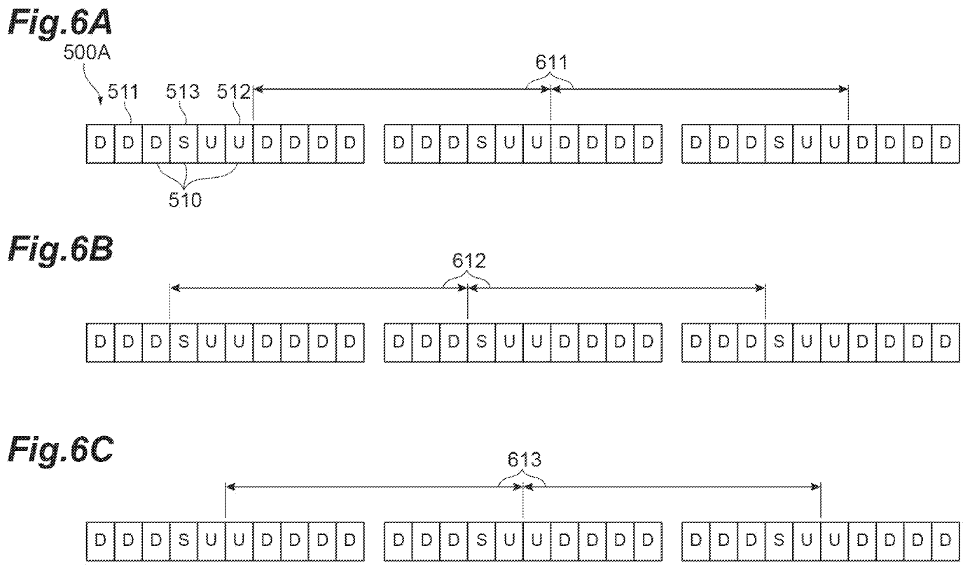

FIGS. 6A, 6B, and 6C are diagrams illustrating the relationship between the time division duplex pattern and the communication cycle in a case where the repetition cycle and the communication cycle are equal to each other. The time division duplex pattern in FIGS. 6A, 6B, and 6C is the time division duplex pattern 500A described above.

In FIG. 6A, the cycle start slot is the seventh communication slot 510 which is the downlink slot 511. In this example, the communication control unit 112 controls the cyclic communication to repeat a communication cycle 611 starting at the seventh communication slot 510 of the time division duplex pattern 500A and ending at the sixth communication slot 510 of the next time division duplex pattern 500A. In the communication cycle 611, seven downlink slots 511, one special slot 513, and two uplink slots 512 are arranged in order. Therefore, according to the example of FIG. 6A, the time division duplex pattern 500A can be used for cyclic communication in which a communication cycle in which the uplink slots 512 are arranged after the downlink slots 511 is repeated.

In FIG. 6B, the cycle start slot is the fourth communication slot 510 which is the special slot 513. In this example, the communication control unit 112 controls the cyclic communication to repeat a communication cycle 612 starting at the fourth communication slot 510 of the time division duplex pattern 500A and ending at the third communication slot 510 of the next time division duplex pattern 500A. In the communication cycle 612, one special slot 513, two uplink slots 512, and seven downlink slots 511 are arranged in order. As mentioned above, the special slot 513 can also be used as the uplink slot 512. Therefore, according to the example of FIG. 6B, the time division duplex pattern 500A can be used for cyclic communication in which a communication cycle in which the downlink slots 511 are arranged after the uplink slots 512 is repeated.

In FIG. 6C, the cycle start slot is the sixth communication slot 510 which is the uplink slot 512. In this example, the communication control unit 112 controls the cyclic communication to repeat a communication cycle 613 starting at the sixth communication slot 510 of the time division duplex pattern 500A and ending at the fifth communication slot 510 of the next the time division duplex pattern 500A. In the communication cycle 613, one uplink slot 512, seven downlink slots 511, one special slot 513, and one uplink slot 512 are arranged in order. Therefore, according to the example of FIG. 6C, the time division duplex pattern 500A can be used for cyclic communication in which a communication cycle in which the downlink slots 511 are arranged after the uplink slot 512 and the uplink slot 512 is arranged after the downlink slot 511 is repeated.

The application 3 may perform cyclic communication in a communication cycle that is an integer fraction of an integer (an integer of two or more) of the repetition cycle. Hereinafter, the integer is referred to as a “multiplication number”. If the communication cycle is an integer fraction of the multiplication number of the repetition cycle, the communication control unit 112 controls the cyclic communication so that one communication cycle is started in the cycle start slot for every consecutive communication cycles of multiplication number.

Further, the communication control unit 112 may control the timing of storing the transmission data in the transmission buffer 211 in each communication cycle so that one communication cycle is performed over two consecutive time division duplex patterns for every consecutive communication cycles of multiplication number. In the communication cycles of the multiplication number, one communication cycle started in the cycle start slot and one communication cycle performed over two time division duplex patterns may be different. For example, the communication control unit 112 may control the cyclic communication so that a first communication cycle performed over two or more time division duplex patterns and a second communication cycle performed within one time division duplex pattern are included in communication cycle of the multiplication number.

The communication control unit 112 may control the cyclic communication so that the numbers of the communication slots 510 used in each of the communication cycles of the multiplication number are equal to each other. The communication control unit 112 may control the cyclic communication so that the numbers of the uplink slots 512 used in each of the communication cycles of the multiplication number are equal to each other. The communication control unit 112 may control the cyclic communication so that the uplink slot 512 is arranged after the downlink slot 511 in each of the communication cycles of the multiplication number. The communication control unit 112 may control the cyclic communication so that the communication cycle of the multiplication number includes a synchronous communication cycle in which the arrangement of the uplink slot 512 and the downlink slot 511 matches another wireless communication performed in parallel with the wireless communication and an asynchronous communication cycle in which the arrangement of the uplink slot 512 and the downlink slot 511 does not match the other wireless communication.

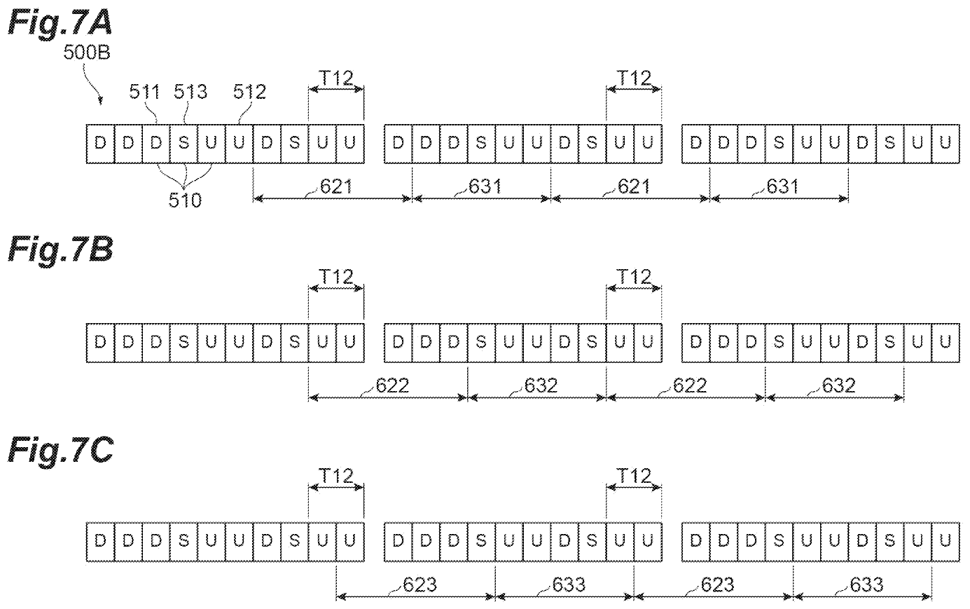

FIGS. 7A, 7B, and 7C are diagrams illustrating the relationship between the time division duplex pattern and the communication cycle in a case where the communication cycle is an integer fraction of the multiplication number of the repetition cycle. The multiplication number in FIGS. 7A, 7B, and 7C is 2, and the time division duplex pattern in FIGS. 7A, 7B, and 7C is the above-described the time division duplex pattern 500B.

In FIG. 7A of the figure, the cycle start slot is the seventh communication slot 510 which is the downlink slot 511. In this example, the communication control unit 112 controls the cyclic communication so as to alternately repeat a communication cycle 621 (a first communication cycle) which starts in the seventh communication slot 510 of the time division duplex pattern 500B and ends in the first communication slot 510 of the next time division duplex pattern 500B, and a communication cycle 631 (a second communication cycle) which starts in the second communication slot 510 of the time division duplex pattern 500B and ends in the sixth communication slot 510 of the same time division duplex pattern 500B. The number of the communication slots 510 included in the communication cycle 621 and the number of the communication slots 510 included in the communication cycle 631 are equal. Therefore, according to the example of FIG. 7A, the same number of the communication slots 510 can be used in each of the communication cycles of multiplication number.

The number of the uplink slots 512 included in the communication cycle 621 and the number of the uplink slots 512 included in the communication cycle 631 are equal. Therefore, according to the example of the FIG. 7A, the same number of the uplink slots 512 can be used in each of the communication cycles of multiplication number.

In the communication cycle 621, one downlink slot 511, one special slot 513, two uplink slots 512, and one downlink slot 511 are arranged in order. In the communication cycle 631, two downlink slots 511, one special slot 513, and two uplink slot 512 are arranged in order. Therefore, according to the example of FIG. 7A, the time division duplex pattern 500B can be used for cyclic communication in which communication cycles in which the uplink slot 512 is arranged after the downlink slot 511 is repeated at double of the time division duplex pattern.

In the example of FIG. 7A, the communication cycle 621 includes the period T12 which is the asynchronous period, and the communication cycle 631 does not include the asynchronous period. Accordingly, the communication cycle 621 corresponds to the asynchronous communication cycle, and the communication cycle 631 corresponds to the synchronous communication cycle.

In FIG. 7B, the cycle start slot is the ninth communication slot 510 which is the uplink slot 512. In this example, the communication control unit 112 controls the cyclic communication so as to alternately repeat a communication cycle 622 (a first communication cycle) which starts at the ninth communication slot 510 of the time division duplex pattern 500B and ends at the third communication slot 510 of the next the time division duplex pattern 500B, and a communication cycle 632 (a second communication cycle) which starts at the fourth communication slot 510 of the time division duplex pattern 500B and ends at the eighth communication slot 510 of the same time division duplex pattern 500B. The number of the communication slots 510 included in the communication cycle 622 and the number of the communication slots 510 included in the communication cycle 632 are equal. Therefore, according to the example of FIG. 7B, the same number of the communication slots 510 can be used in each of the communication cycles of multiplication number.

The number of the uplink slots 512 included in the communication cycle 622 and the number of the uplink slots 512 included in the communication cycle 632 are equal. Therefore, according to the example of FIG. 7B, the same number of the uplink slots 512 can be used in each of the communication cycles of multiplication number.

In the communication cycle 622, two uplink slots 512 and three downlink slots 511 are arranged in order. In the communication cycle 632, one special slot 513, two uplink slots 512, one downlink slot 511, and one special slot 513 are arranged in order. Therefore, according to the example of FIG. 7B, the time division duplex pattern 500B can be used for cyclic communication in which a communication cycle in which the downlink slot 511 is arranged after the uplink slot 512 is repeated at double of the time division duplex pattern.

In the example of FIG. 7B, the communication cycle 622 includes the period T12 which is the asynchronous period, and the communication cycle 632 does not include the asynchronous period. Accordingly, the communication cycle 622 corresponds to the asynchronous communication cycle, and the communication cycle 632 corresponds to the synchronous communication cycle.

In FIG. 7C, the cycle start slot is the tenth communication slot 510 which is the uplink slot 512. In this example, the communication control unit 112 controls cyclic communication so as to alternately repeat a communication cycle 623 (a first communication cycle) which starts in the tenth communication slot 510 of the time division duplex pattern 500B and ends in the fourth communication slot 510 of the next the time division duplex pattern 500B, and a communication cycle 633 (a second communication cycle) which starts in the fifth communication slot 510 of the time division duplex pattern 500B and ends in the ninth communication slot 510 of the same the time division duplex pattern 500B. The number of the communication slots 510 included in the communication cycle 623 and the number of the communication slot 510 included in the communication cycle 633 are equal. Therefore, according to the example of FIG. 7C, the same number of the communication slot 510 can be used in each of the communication cycles of multiplication number.

In the communication cycle 623, one uplink slot 512, three downlink slots 511, and one special slot 513 are arranged in order. In the communication cycle 633, two uplink slots 512, one downlink slot 511, one special slot 513, and one uplink slot 512 are arranged in order. As described above, the special slot 513 can also be used as the uplink slot 512. Therefore, according to the example of FIG. 7C, the time division duplex pattern 500B can be used for cyclic communication in which a communication cycle in which the downlink slot 511 is arranged after the uplink slot 512 and the uplink slot 512 is arranged after the downlink slot 511 is repeated at double of a time division duplex pattern.

In the example of FIG. 7C, both the communication cycle 623 and the communication cycle 633 include the period T12 that is an asynchronous period. Accordingly, both the communication cycle 623 and the communication cycle 623 correspond to the asynchronous communication cycle.

The method of controlling cyclic communication so that at least a part of each of two or more consecutive communication cycles is performed within one time division duplex pattern of wireless communication is not limited to the method of controlling timing at which the transmission data is stored in the transmission buffer 211. For example, the communication control unit 112 may attach a tag specifying the communication slot 510 corresponding to the communication cycle to transmission data and store the transmission data to which the tag is attached in the transmission buffer 211, and the wireless communication unit 213 may transmit the transmission data in the communication slot 510 corresponding to the communication cycle based on the tag attached to the transmission data.

The communication system 1 may be configured to further perform: setting the target arrangement of the downlink slot 511 and the uplink slot 512 in the communication cycle based on configuration information representing the configuration of the device system 10; and controlling the cyclic communication to approximate the arrangement of the downlink slot 511 and the uplink slot 512 in each communication cycle to the target arrangement.

For example, the control server 100 further includes a target setting unit 122. The target setting unit 122 sets a target arrangement of the downlink slot 511 and the uplink slot 512 in the communication cycle based on the configuration information acquired by the configuration information acquisition unit 113. The target setting unit 122 may select the target arrangement corresponding to the configuration of the device system 10 based on a reference table defining the target arrangement for each of a plurality of configurations. In this example, the selected target arrangement becomes a setting result of the target arrangement. The communication control unit 112 controls the cyclic communication so that the arrangement of the downlink slot 511 and the uplink slot 512 in each communication cycle approximates the target arrangement.

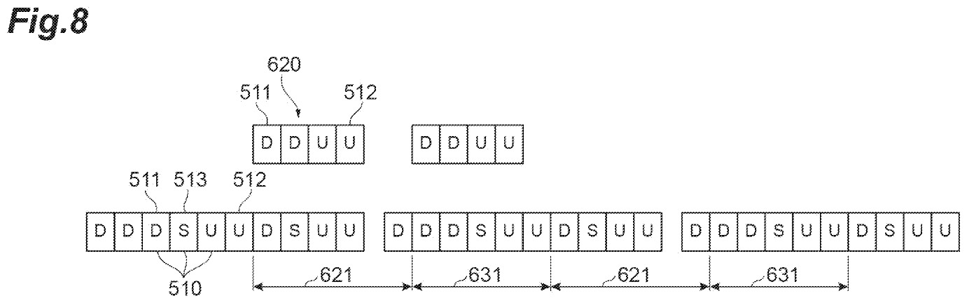

FIG. 8 is a pattern diagram illustrating an example relationship between the target arrangement and the arrangement of the downlink slot 511 and the uplink slot 512 in each communication cycle. FIG. 8 illustrates a case where a target arrangement 620 in which two downlink slots 511 are followed by two uplink slots 512 is set. In response to this, the communication control unit 112 controls cyclic communication so as to repeat the above-described communication cycle 621 and the communication cycle 631 alternately. The special slot 513 can be used as both the downlink slot 511 and the uplink slot 512. Accordingly, both the communication cycle 621 and the communication cycle 631 can be used as a communication cycle in which two downlink slots 511 are followed by two uplink slots 512 in the same manner as the target arrangement 620.

The communication system 1 may be configured to further perform evaluating communication quality in the second type of communication slot 510. For example, the communication system 1 may be configured to further perform evaluating communication quality in the asynchronous slot 522. For example, the control server 100 further includes a communication monitor 131. The communication monitor 131 evaluates communication quality in the asynchronous slot 522.

If the communication cycle of the multiplication number includes the synchronous communication cycle and the asynchronous communication cycle, evaluating the communication quality in the asynchronous slot 522 is an example of evaluating the communication quality in the asynchronous communication cycle.

For example, the communication monitor 131 may evaluate communication quality in the asynchronous slot 522 based on a loss rate of packets of communication in the asynchronous slot 522. For example, the communication monitor 131 may evaluate whether the packet loss rate exceeds a predetermined degradation detection threshold and detect a degradation in communication quality when the packet loss rate exceeds the degradation detection threshold.

The communication monitor 131 may evaluate communication quality in the asynchronous slot 522 based on a level of jitter of communication in the asynchronous slot 522. For example, the communication monitor 131 may evaluate whether the level of the jitter exceeds a predetermined degradation detection threshold, and detect a degradation in communication quality when the level of the jitter exceeds the degradation detection threshold.

The communication system 1 may be configured to switch wireless communication in a normal mode to wireless communication in an irregular mode for coping with a degradation in communication quality when the degradation in communication quality in the second type of communication slot 510 is detected. The wireless communication in the normal mode is, for example, the cyclic communication described above.

Switching from the normal mode to the irregular mode may include: changing the second pattern to the first pattern; and increasing the number of time division duplex patterns corresponding to the control cycle by lengthening the control cycle so as to compensate for a decrease in the number of the uplink slots 512 caused by changing the second pattern to the first pattern.

For example, the communication control unit 112 changes the second pattern to the first pattern when a degradation in communication quality in the asynchronous slot 522 is detected by the communication monitor 131. In addition, the communication control unit 112 increases the number of time division duplex patterns corresponding to the control cycle by lengthening the control cycle so as to compensate for a decrease in the number of the uplink slot 512 caused by changing the second pattern to the first pattern.

Switching the normal mode to the irregular mode may include increasing the number of time division duplex patterns corresponding to one communication cycle by lengthening the communication cycle, and transmitting both transmission data of the first attribute and transmission data of the second attribute to the mobile station 400 by the first type of communication slot 510.

For example, when a degradation in communication quality in the asynchronous slot 522 due to the communication monitor 131 is detected, the communication control unit 112 lengthens the communication cycle of cyclic communication to increase the number of time division duplex patterns corresponding to one communication cycle, and controls the wireless communication unit 213 so that both transmission data of the first attribute and transmission data of the second attribute are transmitted to the mobile station 400 in the synchronous slot 521. The communication control unit 112 may lengthen the control cycle to increase the number of time division duplex patterns corresponding to the control cycle, and increase the communication data transmitted by the synchronous slot 521 and reduce the communication data transmitted by the asynchronous slot 522 when a degradation in communication quality is detected by the communication monitor 131. The communication control unit 112 may extend the communication cycle of the cyclic communication and control the cyclic communication so that each communication cycle becomes asynchronous communication cycle when a degradation in communication quality in the asynchronous slot 522 of an asynchronous communication cycle is detected by the communication monitor 131.

Switching from the normal mode to the irregular mode may include increasing transmission data transmitted by the first type of communication slot 510 by compression of the transmission data.

For example, when a degradation in communication quality in the asynchronous slot 522 is detected by the communication monitor 131, the communication control unit 112 compresses transmission data of the first attribute and transmission data of the second attribute, and controls the wireless communication unit 213 so that both the transmission data of the first attribute and the transmission data of the second attribute are transmitted in the synchronous slot 521.

Switching the normal mode to the irregular mode may include at least partially interrupting transmission of transmission data of the second attribute by the second type of communication slot 510. For example, the communication control unit 112 controls the wireless communication unit 213 so that the transmission of the transmission data of the second attribute by the asynchronous slot 522 is at least partially interrupted when a degradation in communication quality in the asynchronous slot 522 is detected by the communication monitor 131.

Switching from the normal mode to the irregular mode may include increasing a signal strength of wireless communication. For example, the communication control unit 112 requests the wireless communication unit 213 to increase the signal strength of wireless communication when a degradation in communication quality in the asynchronous slot 522 is detected by the communication monitor 131.

The communication system 1 may be configured to from return the irregular mode to the normal mode in a case where recovery of the communication quality that has been reduced is detected. In the irregular mode, when the transmission data of the second attribute is not transmitted by the asynchronous slot 522, the communication quality in the asynchronous slot 522 cannot be evaluated based on the transmission of the transmission data of the second attribute. Therefore, the communication system 1 may be configured to evaluate, in the irregular mode, the communication quality of the transmission data of a third attribute by the asynchronous slot 522 when transmission of the transmission data of the second attribute by the asynchronous slot 522 is not performed.

For example, the communication control unit 112 controls the wireless communication unit 213 so that the transmission data of the third attribute is transmitted to the mobile station 400 by the asynchronous slot 522. The communication control unit 112 may control, in the irregular mode, the wireless communication unit 213 so that the transmission data of the third attribute is transmitted to the mobile station 400 by the asynchronous slot 522 when the transmission of the transmission data of the second attribute by the asynchronous slot 522 is not performed. The transmission data of the third attribute may be dummy data that is not used except for evaluation of communication quality.

The communication monitor 131 may evaluate communication quality of transmission data of the third attribute by the asynchronous slot 522 in a case where transmission of transmission data of the second attribute by the asynchronous slot 522 is not performed. The communication control unit 112 may control the wireless communication unit 213 so as to return from the irregular mode to the normal mode in a case where recovery of communication quality that has been degraded is detected by the communication monitor 131.

The communication system 1 may be configured to transmit the transmission data of the second attribute transmitted by the second type of communication slot 510 again by the second type of communication slot 510 of the next time division duplex pattern in a case where deterioration of communication quality in the second type of communication slot 510 is detected by the communication monitor 131. For example, when a degradation in communication quality in the asynchronous slot 522 is detected by the communication monitor 131, the communication control unit 112 controls the wireless communication unit 213 so that the transmission data of the second attribute transmitted by the asynchronous slot 522 is transmitted again by the asynchronous slot 522 of the next time division duplex pattern. For example, when a degradation in communication quality in the asynchronous slot 522 is detected by the communication monitor 131, the communication control unit 112 leaves the transmission data of the second attribute transmitted in the asynchronous slot 522 to the transmission buffer 211 as a transmission target due to the wireless communication unit 213. The transmission data left in the transmission buffer 211 is transmitted again from the wireless communication unit 213 to the mobile station 400 by the asynchronous slot 522 of the next time division duplex pattern.

The communication system 1 may be configured to further perform evaluating communication quality in the first type of communication slot 510. For example, the communication system 1 may be configured to further perform evaluating communication quality in the synchronous slot 521. The communication system 1 may be configured to shut down the application 3 and reset wireless communication if a degradation in communication quality in the first type of communication slot 510 is detected by the communication monitor 131.

For example, the communication monitor 131 further evaluates the communication quality in the synchronous slot 521. The method of evaluating the communication quality is the same as the method of evaluating the communication quality in the asynchronous slot 522. The communication control unit 112 shuts down the application 3 if a degradation in communication quality in the synchronous slot 521 is detected by the communication monitor 131. For example, when a degradation in communication quality in the synchronous slot 521 is detected by the communication monitor 131, the communication control unit 112 interrupts control of the plurality of machines 20 by the plurality of controllers 111 and stops the operation of the plurality of machines 20.

The control server 100 further includes a reset unit 132. The reset unit 132 requests the wireless communication unit 213 to reset wireless communication after the communication control unit 112 has shut down the application 3. The wireless communication unit 213 resets wireless communication with the mobile station 400 in response to a request from the reset unit 132. For example, the wireless communication unit 213 performs pairing with the mobile station 400 (described later) again.

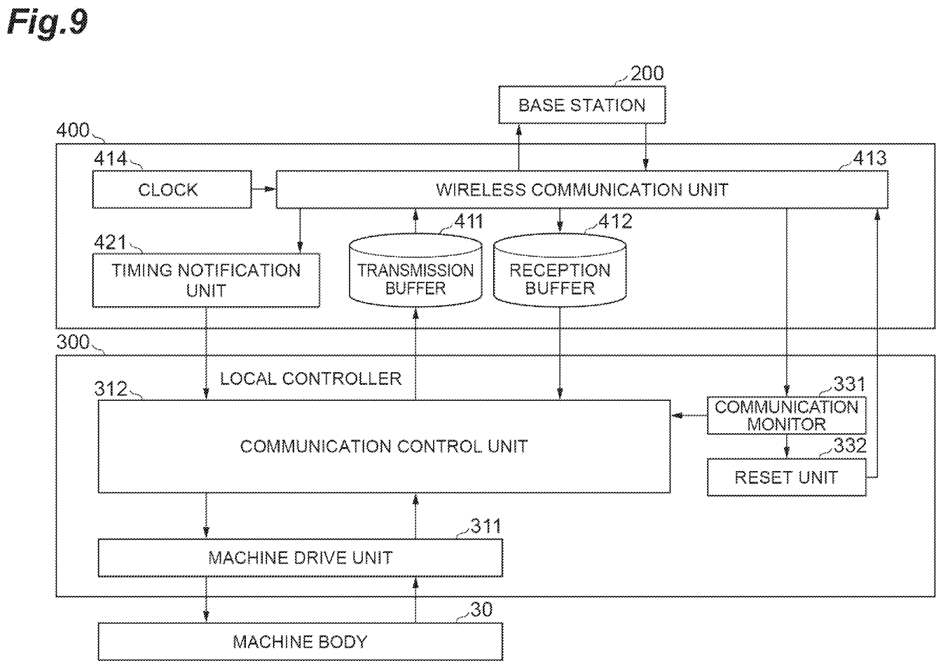

Configuration of Local Controller and Mobile Station FIG. 9 is a block diagram illustrating the configuration of the local controller 300 and the mobile station 400. As illustrated in FIG. 9, the local controller 300 includes a machine drive unit 311 and the communication control unit 312 as functional blocks.

The machine drive unit 311 drives the machine body 30 by repeating a drive cycle including one or more communications from the controller 111 to the machine drive unit 311 and one or more communications from the machine drive unit 311 to the controller 111. For example, the machine drive unit 311 repeats the drive cycle including reception of the command data from the controller 111, output of drive power corresponding to the command data to the machine body 30, acquisition of response data representing an operation of the machine body 30 corresponding to the drive power, and transmission of the command data to the controller 111. For example, the machine drive unit 311 outputs, to the machine body 30, drive power for causing the machine body 30 to generate a target output corresponding to the target output data. The operation of the machine body 30 in accordance with the driving power is an example of the operation realized by the machine 20 in accordance with the command data.

The drive cycle is synchronized with the control cycle and includes the communication cycle. The machine drive unit 311 causes the communication control unit 312 to perform reception of reception data such as command data and transmission of transmission data such as response data. For example, the machine drive unit 311 causes the communication control unit 312 to receive the reception data, and acquires the reception data received by the communication control unit 312. Further, the machine drive unit 311 outputs transmission data to the communication control unit 312 and causes the communication control unit 312 to transmit the transmission data.

The communication control unit 312 performs reception of the reception data and transmission of the transmission data via the mobile station 400. The mobile station 400 includes a transmission buffer 411, a reception buffer 412, a wireless communication unit 413, and a clock 414. The wireless communication unit 413 repeats the time division duplex pattern to perform wireless communication with the base station 200 (counterpart wireless communication unit). For example, the wireless communication unit 413 reads transmission data from the transmission buffer 411 and transmits the transmission data to the base station 200 by an uplink slot of a time division duplex pattern. Further, the wireless communication unit 413 receives reception data from the base station 200 by a downlink slot of the time division duplex pattern and stores the reception data in the reception buffer 412.

The communication control unit 312 is configured to transfer the transmission data from the machine drive unit 311 (second device) to the wireless communication system 2. For example, the communication control unit 312 stores, in the transmission buffer 411, the transmission data acquired from the machine drive unit 311. As described above, the transmission data stored in the transmission buffer 411 is read by the wireless communication unit 413. Therefore, storing transmission data in the transmission buffer 411 is an example of delivering transmission data to the wireless communication unit 413. Data stored in the transmission buffer 411 is transmitted to the controller 111 via the mobile station 400 and the base station 200.

The communication control unit 312 reads, from the reception buffer 412, the reception data that the wireless communication unit 413 has received from the base station 200. Reading the reception data from the reception buffer 412 is an example of acquiring the reception data from the wireless communication unit 413. The reception data is received from the controller 111 via the base station 200 and the mobile station 400 by reading the reception data from the reception buffer 412.

The clock 414 repeatedly generates a time for repetition of the time division duplex pattern. Hereinafter, the time that the clock 414 generates will be referred to as “mobile station time”. The wireless communication unit 413 repeats the time division duplex pattern based on the mobile station time.

For example, the wireless communication unit 413 executes a time division duplex pattern every time a communication clock signal notifying the elapse of a certain repetition cycle is generated. In this example, communication performed from generation of a communication clock signal to generation of the next communication clock signal is one time division duplex pattern.

The wireless communication unit 213 of the base station 200 performs pairing when starting wireless communication with the wireless communication unit 413. The pairing includes synchronization of the start timing of the time division duplex pattern. The wireless communication unit 213 repeats the time division duplex pattern based on the base station time from the start timing synchronized by the pairing. The wireless communication unit 413 repeats the time division duplex pattern based on the mobile station time from the start timing synchronized by the pairing.

The pairing includes notification of the time division duplex pattern set by the communication pattern setting unit 114. The wireless communication unit 213 repeats the time division duplex pattern notified in the pairing.

Similarly to the communication control unit 112, the communication control unit 312 may cause, if transmission data generated by the machine drive unit 311 has the first attribute, the transmission data to be transmitted from the wireless communication unit 413 to the base station 200 by the first type of communication slot 510, and may cause, if transmission data generated by the machine drive unit 311 has the second attribute, the transmission data to be transmitted from the wireless communication unit 413 to the base station 200 by the second type of communication slot 510.

The first attribute may be a first priority, and the second attribute may be a second priority lower than the first priority. The communication control unit 312 may control the wireless communication unit 413 so that transmission data having a first priority is transmitted to the base station 200 by the synchronous slot 521 and transmission data having a second priority is transmitted to the base station 200 by the asynchronous slot 522.

The first attribute may be “being the control data”, and the communication control unit 312 may control the wireless communication unit 413 so that the transmission data is transmitted in the synchronous slot 521 when the transmission data is the control data. The second attribute may be “being a data of a predetermined type different from the control data”, and the communication control unit 312 may control the wireless communication unit 413 so that the transmission data is transmitted in the asynchronous slot 522 when the transmission data is the data of the predetermined type.

The first attribute may be “being fault notification data notifying a fault of the machine 20”, and the communication control unit 312 may control the wireless communication unit 413 so that the transmission data is transmitted in the synchronous slot 521 when the transmission data is the fault notification data. The second attribute may be “being notification data of a predetermined type which is less urgent than the fault notification data”. In this example, the communication control unit 312 may control the wireless communication unit 413 so that the transmission data is transmitted in the asynchronous slot 522 when the transmission data is the notification data of the predetermined type.

As described above, the communication control unit 312 controls which of the communication slots 510 is used to transmit the transmission data based on the attribute of the transmission data. In order to perform such control, the communication control unit 312 acquires attribute information indicating an attribute of the transmission data from the machine drive unit 311 together with the transmission data. The communication control unit 312 attaches a tag indicating the attribute of the transmission data to the transmission data based on the acquired attribute information, and stores the transmission data to which the tag is attached in the transmission buffer 411. The wireless communication unit 413 controls by which the communication slot 510 the transmission data is transmitted based on the tag attached to the transmission data.

For example, when the transmission data has a first attribute, the communication control unit 312 adds a first tag and stores the transmission data in the transmission buffer 411, and when the transmission data has a second attribute, the communication control unit 312 adds a second tag and stores the transmission data in the transmission buffer 411. The wireless communication unit 413 transmits the transmission data to the base station 200 by the first type of communication slot 510 when the first tag is attached to transmission data, and transmits the transmission data to the base station 200 by the second type of communication slot 510 when the second tag is attached to transmission data.

The method of controlling by which communication slot 510 the transmission data is transmitted based on the attribute of the transmission data is not limited to the method of attaching a tag to the transmission data. For example, the communication control unit 312 may determine by which communication slot 510 the transmission data is to be transmitted based on the attribute of the transmission data, and control the timing at which the transmission data is stored in the transmission buffer 411 so that the transmission data is transmitted by the determined communication slot 510.

In this example, the mobile station 400 further includes a timing notification unit 421. The timing notification unit 421 notifies the communication control unit 312 of the start timing of the time division duplex pattern. The communication control unit 312 recognizes the execution timing of each communication slot 510 based on the start timing of the time division duplex pattern, and controls the timing for storing the transmission data in the transmission buffer 411 so that the transmission data is transmitted in the determined the communication slot 510.

Similarly to the communication control unit 112, the communication control unit 312 may control the cyclic communication so that at least a portion of each of two or more consecutive communication cycles of the cyclic communication is performed within one time division duplex pattern of the wireless communication. For example, the communication control unit 312 performs the cyclic communication in cooperation with the communication control unit 112. An example of the cyclic communication realized by the communication control unit 312 in cooperation with the communication control unit 112 is as described in detail in the description of the communication control unit 112.

The communication control unit 112 of the control server 100 performs the pairing when starting the cyclic communication with the communication control unit 312. The pairing includes notification of the relationship between the time division duplex pattern and the communication cycle. The communication control unit 312 repeats the communication cycle in cooperation with the communication control unit 112 so as to maintain the relationship between the notified time division duplex pattern and the communication cycle.

For example, when the repetition cycle is equal to the communication cycle, the pairing includes notification of the cycle start slot. The communication control unit 312 recognizes the execution timing of the cycle start slot based on the start timing of the time division duplex pattern acquired from the timing notification unit 421. The communication control unit 312 controls the timing of storing the transmission data in the transmission buffer 411 in each communication cycle equal to the repetition cycle so that the one communication cycle is started in the cycle start slot based on the timing of executing the cycle start slot.

For example, when the communication cycle is an integer fraction of the multiplication number of the repetition cycle, the pairing includes notification of the cycle start slot and the multiplication number. The communication control unit 312 recognizes the execution timing of the cycle start slot based on the start timing of the time division duplex pattern acquired from the timing notification unit 421. Based on the execution timing of the cycle start slot, the communication control unit 312 controls the timing at which the transmission data is stored in the transmission buffer 411 in each communication cycle that is an integer fraction of the multiplication number of the repetition cycle so that the one communication cycle is started in the cycle start slot.

The local controller 300 may further have a communication monitor 331, which is similar to the communication monitor 131 of the control server 100. The communication monitor 331 evaluates communication quality in the asynchronous slot 522.

When the communication cycle of the multiplication number includes the synchronous communication cycle and the asynchronous communication cycle, evaluating the communication quality in the asynchronous slot 522 is an example of evaluating the communication quality in the asynchronous communication cycle.

For example, the communication monitor 331 may evaluate the communication quality in the asynchronous slot 522 based on a loss rate of packets of communication in the asynchronous slot 522. For example, the communication monitor 331 may evaluate whether the packet loss rate exceeds a predetermined degradation detection threshold and detect a degradation in the communication quality when the packet loss rate exceeds the degradation detection threshold.

The communication monitor 331 may evaluate the communication quality in the asynchronous slot 522 based on a level of jitter of communication in the asynchronous slot 522. For example, the communication monitor 331 may evaluate whether the level of the jitter exceeds a predetermined degradation detection threshold, and detect a degradation in the communication quality when the level of the jitter exceeds the degradation detection threshold.

The communication control unit 312 may transmit a switching request from the normal mode to the irregular mode to the communication control unit 112 when a degradation in the communication quality in the asynchronous slot 522 is detected by the communication monitor 331. When the communication control unit 112 receives the switching request, the switching from the normal mode to the irregular mode may be performed in the same manner as when a degradation in the communication quality in the asynchronous slot 522 is detected by the communication monitor 131.

When the communication control unit 112 lengthens the communication cycle of the cyclic communication to increase the number of time division duplex patterns corresponding to one communication cycle, the communication control unit 312 may control the wireless communication unit 413 so that both the transmission data of the first attribute and the transmission data of the second attribute are transmitted to the base station 200 by the synchronous slot 521. The communication control unit 312 may increase the communication data transmitted by the synchronous slot 521 and reduce the communication data transmitted by the asynchronous slot 522.

When a degradation in the communication quality in the asynchronous slot 522 is detected by the communication monitor 331, the communication control unit 312 may control the wireless communication unit 413 so as to compress the transmission data of the first attribute and the transmission data of the second attribute and transmit both the transmission data of the first attribute and the transmission data of the second attribute in the synchronous slot 521. The communication control unit 312 may control the wireless communication unit 413 so that transmitting the transmission data of the second attribute by the asynchronous slot 522 is at least partially interrupted when a degradation in the communication quality at the asynchronous slot 522 by the communication monitor 331 is detected. The communication control unit 312 may request an increase in the signal strength of the wireless communication to the wireless communication unit 413 in communication quality at the asynchronous slot 522 is detected by the communication monitor 331.

The communication control unit 312 may control the wireless communication unit 413 so that transmission data of the third attribute is transmitted by the asynchronous slot 522 to the base station 200. The communication control unit 312 may control the wireless communication unit 413 so that the transmission data of the third attribute is transmitted to the base station 200 by the asynchronous slot 522 when the transmission of the transmission data of the second attribute by the asynchronous slot 522 is not performed in the irregular mode. The transmission data of the third attribute may be dummy data that is not used except for evaluation of the communication quality.

The communication monitor 331 may evaluate the communication quality of transmission data of the third attribute by the asynchronous slot 522 in a case where transmission of transmission data of the second attribute by the asynchronous slot 522 is not performed. The communication control unit 312 may transmit a recovery request from the irregular mode to the normal mode to the communication control unit 112 when the recovery of the communication quality that has been degraded is detected by the communication monitor 331. When receiving the recovery request, the communication control unit 112 may perform switching from the normal mode to the irregular mode as in the case where recovery of communication quality is detected by the communication monitor 131.

The communication control unit 312 may control the wireless communication unit 413 so as to return the irregular mode to the normal mode when recovery of communication quality that has been reduced is detected by the communication monitor 331.

The communication system 1 may be configured to transmit the transmission data of the second attribute transmitted by the second type of communication slot 510 again by the second type of communication slot 510 of the next time division duplex pattern when degradation of communication quality in the second type of communication slot 510 is detected by the communication monitor 331. For example, when a degradation in communication quality in the asynchronous slot 522 is detected by the communication monitor 331, the communication control unit 312 controls the wireless communication unit 413 so that the transmission data of the second attribute transmitted by the asynchronous slot 522 is transmitted again due to the asynchronous slot 522 of the next time division duplex pattern. For example, when a degradation in the communication quality in the asynchronous slot 522 is detected by the communication monitor 331, the communication control unit 312 leaves, in the transmission buffer 411, the transmission data of the second attribute transmitted by the asynchronous slot 522 as a transmission target due to the wireless communication unit 413. The transmission data left in the transmission buffer 411 is transmitted again from the wireless communication unit 413 to the mobile station 400 by the asynchronous slot 522 of the next time division duplex pattern.

The communication monitor 331 may further evaluate communication quality in the synchronous slot 521. The method of evaluating the communication quality is the same as the method of evaluating communication quality in the asynchronous slot 522. The communication control unit 312 shuts down the application 3 if a degradation in communication quality in the synchronous slot 521 is detected by the communication monitor 331. For example, the communication control unit 312 sends stop request for the plurality of machines 20 to the communication control unit 112 if a degradation in communication quality in the synchronous slot 521 is detected by the communication monitor 331. The communication control unit 112 receiving the stopping request interrupts the control of the plurality of machines 20 by the plurality of controllers 111 and stops the plurality of machines 20.

The local controller 300 further includes a reset unit 332. The reset unit 332 requests a reset of wireless communication to the wireless communication unit 413 after the communication control unit 312 has shut down the application 3. The wireless communication unit 413 resets wireless communication with the base station 200 in response to the request from the reset unit 332. For example, the wireless communication unit 413 requests the wireless communication unit 213 to perform the pairing again.

### Hardware Configuration

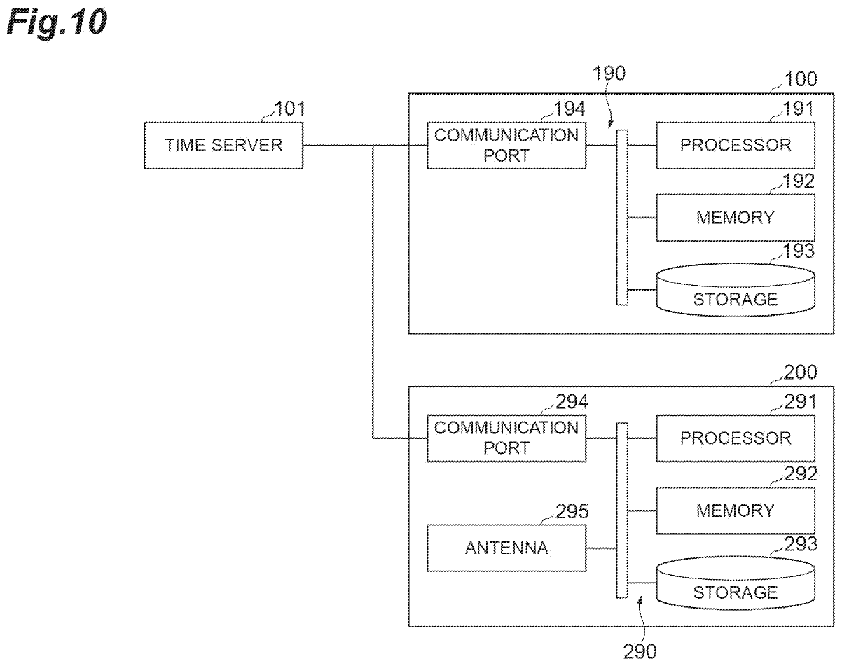

FIG. 10 is a block diagram illustrating hardware configurations of the control server 100 and the base station 200. As illustrated in FIG. 10, the control server 100 includes circuitry 190. The circuitry 190 includes communication control circuitry that controls the cyclic communication. The circuitry 190 includes a processor 191, a memory 192, storage 193, and a communication port 194.

The storage 193 is a nonvolatile storage medium. Examples of the storage 193 include a hard disk and a flash memory. The storage 193 may be a portable storage medium such as an optical disk. The storage 193 may store a program for causing the control server 100 to execute: obtaining configuration information indicating the configuration of the device system 10; setting a time division duplex pattern that defines an arrangement of a downlink slot of time division duplex and an uplink slot of the time division duplex in accordance with a configuration of the device system 10; and repeating the set time division duplex pattern to perform wireless communication.

The storage 193 may store a program for causing the control server 100 to transmit transmission data from the base station 200 (a wireless communication unit) to the mobile station 400 (a counterpart wireless communication unit) by a first type of communication slot when the transmission data has a first attribute, and to transmit transmission data from the base station 200 (the wireless communication unit) to the mobile station 400 (the counterpart wireless communication unit) by a second type of communication slot when the transmission data has a second attribute.

The storage 193 may store a program that causes the control server 100 to execute: performing cyclic communication using the wireless communication system 2; and controlling the cyclic communication so that at least a part of each of two or more consecutive communication cycles of the cyclic communication is performed within one time division duplex pattern of the wireless communication.

For example, the storage 193 stores a program for configuring each functional block described above in the control server 100.

The memory 192 is a temporary storage medium such as a random-access memory, and temporarily stores the program loaded from the storage 193. The processor 191 is configured by one or more arithmetic elements, and causes the control server 100 to configure each functional block by executing the program loaded into the memory 192. The communication port 194 communicates with the time server 101 and the base station 200 in response to requests from the processor 191.

The base station 200 includes circuitry 290. The circuitry 290 includes a processor 291, a memory 292, storage 293, and a communication port 294.

The storage 293 is a nonvolatile storage medium. Examples of the storage 293 include a hard disk and a flash memory. The storage 293 may be a portable storage medium such as an optical disk. The storage 293 stores a program for configuring each functional block described above in the base station 200.

The memory 292 is a temporary storage medium such as a random-access memory, and temporarily stores the program loaded from the storage 293. The processor 291 is configured by one or more arithmetic elements, and causes the base station 200 to configure each functional block by executing the program loaded into the memory 292. The communication port 294 communicates with the communication port 194 in response to requests from the processor 291. An antenna 295 transmits and receives a signal for wireless communication in response to requests from the processor 291.

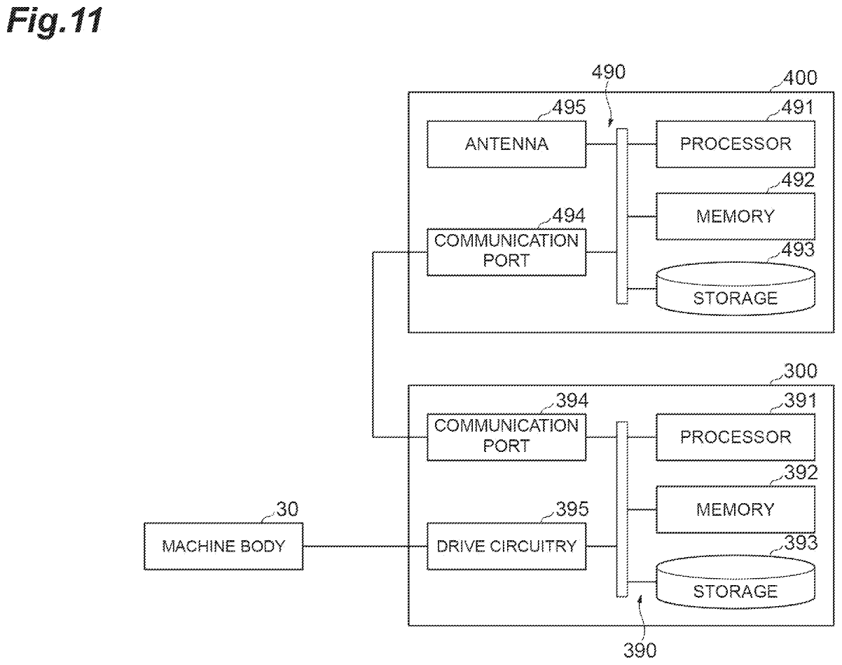

FIG. 11 is a block diagram illustrating hardware configurations of the local controller 300 and the mobile station 400. As illustrated in FIG. 11, the local controller 300 includes circuitry 390. The circuitry 390 includes a communication control circuit that controls the cyclic communication. The circuitry 390 includes a processor 391, a memory 392, storage 393, a communication port 394, and drive circuitry 395.

The storage 393 is a nonvolatile storage medium. Examples of the storage 393 include a hard disk and a flash memory. The storage 393 may be a portable storage medium such as an optical disk. The storage 393 may store a program for causing the local controller 300 to execute: transmitting transmission data from the mobile station 400 (a wireless communication unit) to the base station 200 (a counterpart wireless communication unit) by a first type of communication slot when the transmission data has the first attribute; and transmitting transmission data from the mobile station 400 (the wireless communication unit) to the base station 200 (the counterpart wireless communication unit) by a second type of communication slot when the transmission data has the second attribute.

The storage 393 may store a program that causes the local controller 300 to execute: performing cyclic communication using the wireless communication system 2; and controlling the cyclic communication so that at least a part of each of two or more consecutive communication cycles of the cyclic communication is performed within one time division duplex pattern of the wireless communication.

For example, the storage 393 stores a program for configuring each functional block described above in the local controller 300.

The memory 392 is a temporary storage medium such as a random-access memory, and temporarily stores the program loaded from the storage 393. The processor 391 is configured by one or more arithmetic elements, and causes the local controller 300 to configure each functional block by executing the program loaded into the memory 392. The communication port 394 communicates with the mobile station 400 in response to requests from the processor 391.

The drive circuitry 395 outputs drive power to the machine body 30 and acquires response data from the machine body 30 in response to request from the processor 391.

The mobile station 400 includes circuitry 490. The circuitry 490 includes a processor 491, a memory 492, storage 493, and a communication port 494.

The storage 493 is a nonvolatile storage medium. Examples of the storage 493 include a hard disk and a flash memory. The storage 493 may be a portable storage medium such as an optical disk. The storage 493 stores a program for configuring each functional block described above in the mobile station 400.

The memory 492 is a temporary storage medium such as a random-access memory, and temporarily stores the program loaded from the storage 493. The processor 491 is configured by one or more arithmetic elements, and causes the mobile station 400 to configure each functional block by executing the program loaded into the memory 492. The communication port 494 communicates with the communication port 494 in response to requests from the processor 491. An antenna 495 transmits and receives a signal for wireless communication in response to requests from the processor 491.

Communication Procedure by Control Server and Base Station As an example of the communication method, a communication procedure by the control server 100 and the base station 200 will be illustrated. The procedure includes: acquiring configuration information indicating a configuration of the device system 10; setting a time division duplex pattern in accordance with the configuration of the device system 10; and performing wireless communication by repeating the set time division duplex pattern.

The procedure also includes: causing the transmission data to be transmitted from the wireless communication unit 213 to the mobile station 400 by the first type of communication slot 510 if the transmission data has the first attribute; and causing the transmission data to be transmitted from the wireless communication unit 213 to the mobile station 400 by the second type of communication slot 510 if the transmission data has the second attribute.

The procedure also includes: performing cyclic communication using the wireless communication system 2; and controlling the cyclic communication so that at least a portion of each of two or more consecutive communication cycles of the cyclic communication is performed within one time division duplex pattern of the wireless communication.

Hereinafter, this procedure will be described in detail by dividing it into setting procedure of the time division duplex pattern and the cycle start slot, a wireless communication procedure, a communication control procedure, and a communication mode changing procedure.

(Setting Procedure of Time Division Duplex Pattern and Cycle Start Slot)

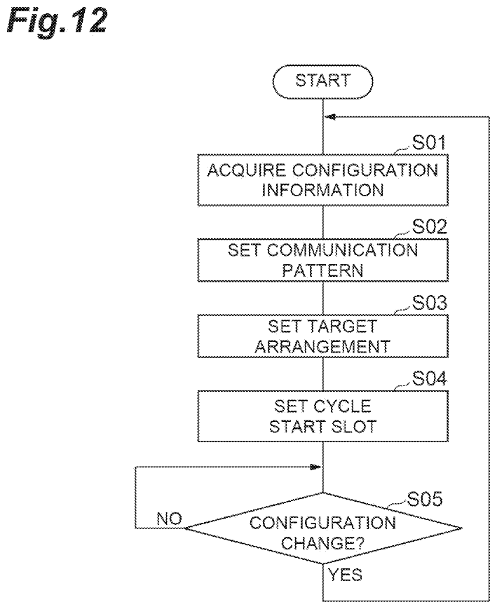

As illustrated in FIG. 12, the control server 100 first executes operations S01 and S02 in order. In the operation S01, the configuration information acquisition unit 113 acquires configuration information indicating a configuration of the device system 10 from the plurality of controllers 111. In the operation S02, the communication pattern setting unit 114 sets a time division duplex pattern in accordance with the configuration of the device system 10.

Next, the control server 100 performs operations S03, S04, and S05. In the operation S03, the target setting unit 122 sets the target arrangement of the downlink slot 511 and the uplink slot 512 in the communication cycle. In the operation S04, the communication control unit 112 sets the cycle start slot so that the arrangement of the downlink slot 511 and the uplink slot 512 in each communication cycle approximates the target arrangement. In the operation S05, the configuration information acquisition unit 113 waits for the configuration of the device system 10 to change. The control server 100 then returns the processing to the operation S01. By the above procedure, the time division duplex pattern and the cycle slot are set in the control server 100 every time the configuration of the device system 10 changes.

### Wireless Communication Procedure

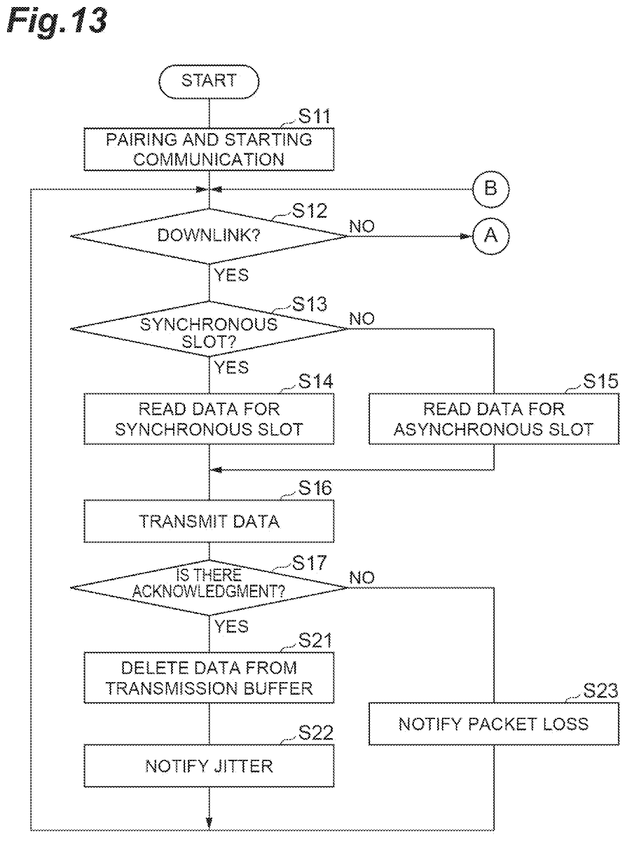

As illustrated in FIG. 13, the base station 200 performs operations S11 and S12 in sequence. In the operation S11, the wireless communication unit 213 performs pairing with the wireless communication unit 413 and starts wireless communication by the set time division duplex pattern. In the operation S12, the wireless communication unit 213 checks whether the current the communication slot 510 is the downlink slot 511.

If it is determined in the operation S12 that the current the communication slot 510 is the downlink slot 511, the base station 200 executes an operation S13. In the operation S13, the wireless communication unit 213 checks if the current the communication slot 510 is the synchronous slot 521.

If it is determined in the operation S13 that the current the communication slot 510 is the synchronous slot 521, the base station 200 executes an operation S14. In the operation S14, the wireless communication unit 213 reads transmission data for the synchronous slot 521 from the transmission buffer 211 based on a tag attached to the transmission data. For example, the wireless communication unit 213 reads the transmission data of the first attribute to which the first tag is attached from the transmission buffer 211.

If it is determined in the operation S13 that the current communication slot is an asynchronous slot, the base station 200 executes an operation S15. In the operation S15, the wireless communication unit 213 reads transmission data for the asynchronous slot 522 from the transmission buffer 211 based on a tag attached to the transmission data. For example, the wireless communication unit 213 reads the transmission data of the second attribute to which the second tag is attached from the transmission buffer 211.

Next, the base station 200 executes operations S16 and S17. In the operation S16, the wireless communication unit 213 transmits the transmission data read from the transmission buffer 211 to the wireless communication unit 413. In the operation S17, the wireless communication unit 213 checks whether there is an acknowledgement from the wireless communication unit 413.

If it is determined in the operation S17 that there is an acknowledgement, the base station 200 executes operations S21 and S22. In the operation S21, the wireless communication unit 213 deletes the transmitted transmission data from the transmission buffer 211. In the operation S22, the wireless communication unit 213 notifies the communication monitor 131 of the level of jitter based on the reception timing of the acknowledgement.

If it is determined in the operation S17 that there is no acknowledgement, the base station 200 executes an operation S23. In the operation S23, the wireless communication unit 213 notifies the communication monitor 131 of the occurrence of packet loss. The base station 200 then returns the processing to the operation S12.

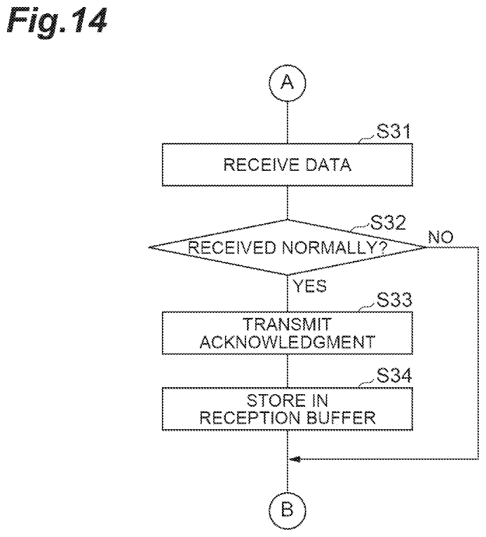

If it is determined in the operation S12 that the current the communication slot 510 is the uplink slot 512, the base station 200 executes operations S31 and S32 as illustrated in FIG. 14. In the operation S31, the wireless communication unit 213 receives reception data from the wireless communication unit 413. In the operation S32, the wireless communication unit 213 checks whether the reception data has been successfully received.

If it is determined in the operation S32 that the reception data has been successfully received, the base station 200 executes operations S33 and S34. In the operation S33, the wireless communication unit 213 sends an acknowledgement to the wireless communication unit 413. In the operation S34, the wireless communication unit 213 stores reception data in the reception buffer 212. The base station 200 then returns the processing to the operation S12.

If it is determined in the operation S32 that the reception data could not be received normally, the base station 200 returns the processing to the operation S12 without performing the operations S33 and S34. By repeating the above procedure, the base station 200 executes communication for each communication slot in a time-division manner.

### Communication Control Procedure

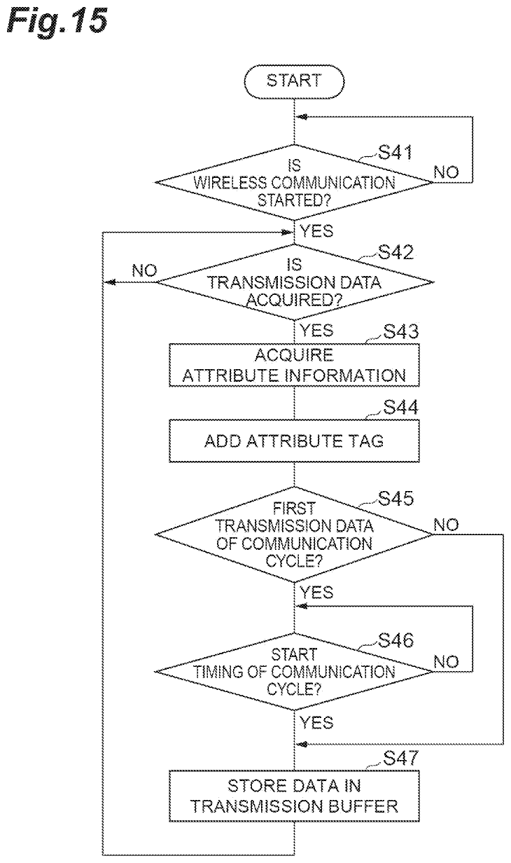

As illustrated in FIG. 15, the control server 100 first performs operations S41, S42, S43, and S44. In the operation S41, the communication control unit 112 waits for initiation of wireless communication by the wireless communication unit 213. In the operation S42, the communication control unit 112 waits for acquisition of transmission data from the controller 111. In the operation S43, the communication control unit 112 acquires attribute information of transmission data from the controller 111. In the operation S44, the communication control unit 112 adds a tag representing an attribute of transmission data to the transmission data based on the attribute information.

Next, the control server 100 performs an operation S45. In the operation S45, the communication control unit 112 checks whether the transmission data is the first transmission data of the communication cycle.

If it is determined in the operation S45 that the transmission data is the first transmission data of the communication cycle, the control server 100 executes an operation S46. In the operation S46, the communication control unit 112 waits for the start timing of the next communication cycle.

Next, the control server 100 executes an operation S47. If it is determined in the operation S45 that the transmission data is not the first transmission data of the communication cycle, the control server 100 executes the operation S47 without executing the operation S46. In the operation S47, the communication control unit 112 stores transmission data in the transmission buffer 211. The control server 100 then returns the processing to the operation S42.

After that, acquisition of transmission data, addition of a tag to the transmission data, adjustment of storage timing of the transmission data, and storage of the transmission data in the transmission buffer 211 are repeated. The transmission data is transmitted, based on the attribute represented by the tag, from the wireless communication unit 213 to the wireless communication unit 413 by the communication slot 510 suitable for the attribute. The relationship between the time division duplex pattern and the communication cycle is appropriately maintained by adjusting the storage timing of the transmission data.

### Procedure of Switching Communication Mode

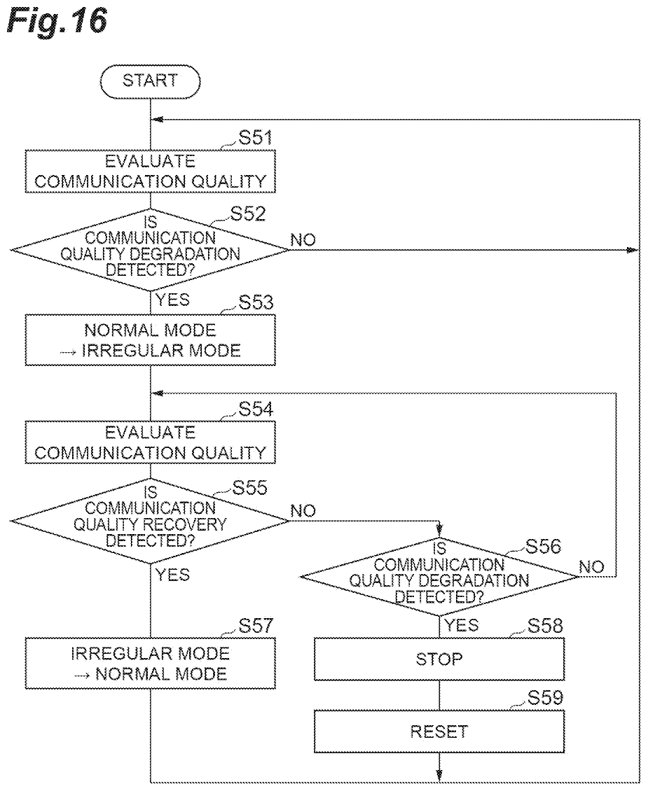

As illustrated in FIG. 16, the control server 100 first executes operations S51 and S52. In the operation S51, the communication monitor 131 evaluates communication quality in the asynchronous slot 522. In the operation S52, the communication monitor 131 checks whether the communication quality in the asynchronous slot 522 has been degraded.

If no degradation in communication quality is detected in the operation S52, the control server 100 returns processing to the operation S51. If a degradation in communication quality is detected in the operation S52, the control server 100 executes an operation S53. In the operation S53, the communication control unit 112 switches the normal mode to the irregular mode.

Next, the control server 100 executes operations S54 and S55. In the operation S54, the communication monitor 131 evaluates communication quality in the asynchronous slot 522 and communication quality in the synchronous slot 521. In the operation S55, the communication monitor 131 checks whether communication quality in the asynchronous slot 522 has been recovered.

If no recovery of communication quality is detected in the operation S55, the control server 100 executes an operation S56. In the operation S56, the communication monitor 131 checks whether the communication quality in the synchronous slot 521 has been degraded. If no degradation in communication quality is detected in the operation S56, the control server 100 returns processing to the operation S54.

If the recovery of communication quality is detected in the operation S55, the control server 100 executes an operation S57. In the operation S57, the communication control unit 112 switches from irregular mode to normal mode.

If a degradation in communication quality is detected in the operation S56, the control server 100 executes operations S58 and S59. In the operation S58, the communication control unit 112 interrupts the control of the plurality of machines 20 by the plurality of controllers 111 and stops the movement of the machines 20 if a degradation in communication quality in the synchronous slot 521 is detected by the communication monitor 131. In the operation S59, the reset unit 132 requests the wireless communication unit 213 to reset wireless communication after the communication control unit 112 has stopped the plurality of machines 20. The wireless communication unit 213 resets wireless communication with the mobile station 400 in response to the request from the reset unit 132.

After executing the operation S57 or the operation S59, the control server 100 returns the process to the operation S51. The control server 100 repeats the above procedure.

Communication Procedure by Local Controller and Mobile Station

As an example of the communication method, a communication procedure by the local controller 300 and the mobile station 400 is further illustrated. The procedure includes: causing transmission data to be transmitted by the first type of communication slot 510 from the wireless communication unit 413 to the base station 200 if the transmission data has the first attribute; and causing transmission data to be transmitted by the second type of communication slot 510 from the wireless communication unit 413 to the base station 200 if the transmission data has the second attribute.

The procedure also includes: performing cyclic communication using the wireless communication system 2; and controlling the cyclic communication so that at least a part of each of two or more consecutive communication cycles of the cyclic communication is performed within one time division duplex pattern of the wireless communication.

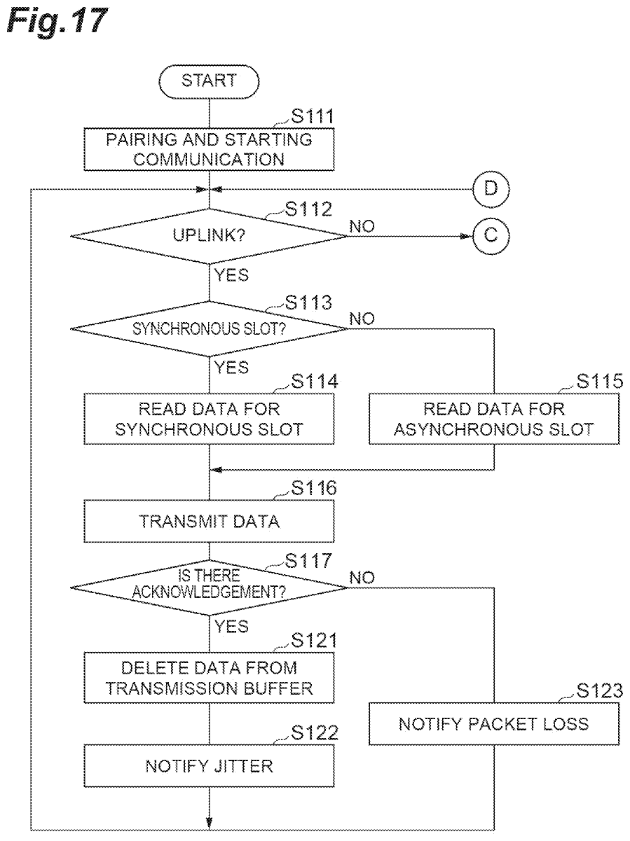

Hereinafter, this procedure will be described in detail by dividing it into a wireless communication procedure, a communication control procedure, and a communication mode change procedure. (Wireless Communication Procedure) As illustrated in FIG. 17, the mobile station 400 executes operations S111 and S112 in sequence. In the operation S111, the wireless communication unit 413 responds to pairing by the wireless communication unit 213 and starts wireless communication by time division duplex pattern notified from the wireless communication unit 213. In the operation S112, the wireless communication unit 413 checks whether the current the communication slot 510 is the uplink slot 512.

If it is determined in the operation S112 that the current the communication slot 510 is the uplink slot 512, the mobile station 400 executes an operation S113. In the operation S113, the wireless communication unit 413 checks whether the current the communication slot 510 is the synchronous slot 521.

If it is determined in the operation S113 that the current the communication slot 510 is the synchronous slot 521, the mobile station 400 executes an operation S114. In the operation S114, the wireless communication unit 413 reads transmission data for the synchronous slot 521 from the transmission buffer 411 based on the tag attached to the transmission data. For example, the wireless communication unit 413 reads the transmission data of the first attribute to which the first tag is attached from the transmission buffer 411.

If it is determined in the operation S113 that the current communication slot is the asynchronous slot, the mobile station 400 executes an operation S115. In the operation S115, the wireless communication unit 413 reads transmission data for the asynchronous slot 522 from the transmission buffer 411 based on the tag attached to the transmission data. For example, the wireless communication unit 413 reads the transmission data of the second attribute to which the second tag is attached from the transmission buffer 411.

Next, the mobile station 400 executes operations S116 and S117. In the operation S116, the wireless communication unit 413 transmits the transmission data read from the transmission buffer 411 to the wireless communication unit 213. In the operation S117, the wireless communication unit 413 checks whether there is an acknowledgement from the wireless communication unit 213.

If it is determined in the operation S117 that there is an acknowledgement, the mobile station 400 executes operations S121 and S122. In the operation S121, the wireless communication unit 413 deletes the transmitted transmission data from the transmission buffer 411. In the operation S122, the wireless communication unit 413 notifies the communication monitor 331 of the level of jitter based on the reception timing of the acknowledgement.

If it is determined that there is no acknowledgement in the operation S117, the mobile station 400 executes an operation S123. In the operation S123, the wireless communication unit 413 notifies the communication monitor 331 of the occurrence of packet loss. The mobile station 400 then returns the processing to the operation S112.

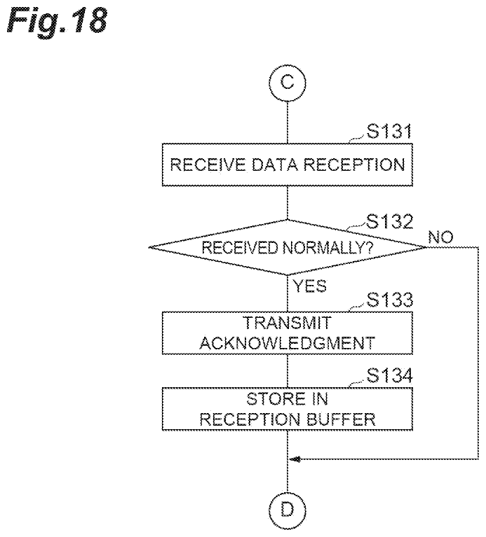

If it is determined in the operation S112 that the current the communication slot 510 is the uplink slot 512, the mobile station 400 executes operations S131 and S132, as illustrated in FIG. 18. In the operation S131, the wireless communication unit 413 receives reception data from the wireless communication unit 213. In the operation S132, the wireless communication unit 413 checks whether the reception data has been successfully received.

If it is determined in the operation S132 that the reception data has been successfully received, the mobile station 400 executes operations S133 and S134. In the operation S133, the wireless communication unit 413 sends an acknowledgement to the wireless communication unit 213. In the operation S134, the wireless communication unit 413 stores reception data in the reception buffer 412. The mobile station 400 then returns the processing to the operation S112.

If it is determined in the operation S132 that the reception data has not been successfully received, the mobile station 400 returns the processing to the operation S112 without executing the operations S133 and S134. By repeating the above procedure, the mobile station 400 executes communication for each communication slot in a time-division manner.

### Communication Control Procedure

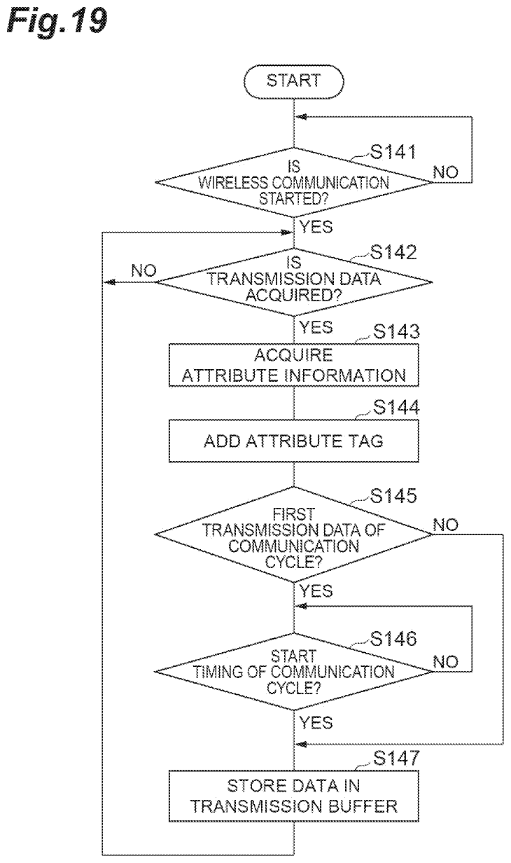

As illustrated in FIG. 19, the local controller 300 first performs operations S141, S142, S143, and S144. In the operation S141, the communication control unit 312 waits for initiation of wireless communication by the wireless communication unit 413. In the operation S142, the communication control unit 312 waits for acquisition of transmission data from the machine drive unit 311. In the operation S143, the communication control unit 312 acquires attribute information of transmission data from the machine drive unit 311. In the operation S144, the communication control unit 312 adds a tag representing the attribute of transmission data to the transmission data based on the attribute information.

Next, the local controller 300 executes an operation S145. In the operation S145, the communication control unit 312 checks whether the transmission data is the first transmission data of the communication cycle.

If it is determined in the operation S145 that the transmission data is the first transmission data of the communication cycle, the local controller 300 executes an operation S146. In the operation S146, the communication control unit 312 waits for the start timing of the next communication cycle.

Next, the local controller 300 executes an operation S147. If it is determined in the operation S145 that the transmission data is not the first transmission data of the communication cycle, the local controller 300 executes the operation S147 without executing the operation S146. In the operation S147, the communication control unit 312 stores transmission data in the transmission buffer 411. The local controller 300 then returns the processing to the operation S142.

After that, acquisition of the transmission data, addition of the tag to the transmission data, adjustment of storage timing of the transmission data, and storage of the transmission data in the transmission buffer 411 are repeated. The transmission data is transmitted from the wireless communication unit 413 to the wireless communication unit 213 by the communication slot 510 suitable for the attribute based on the attribute represented by the tag. The relationship between the time division duplex pattern and the communication cycle may be maintained by adjusting the storage timing of the transmission data.

### Procedure of Switching Communication Mode

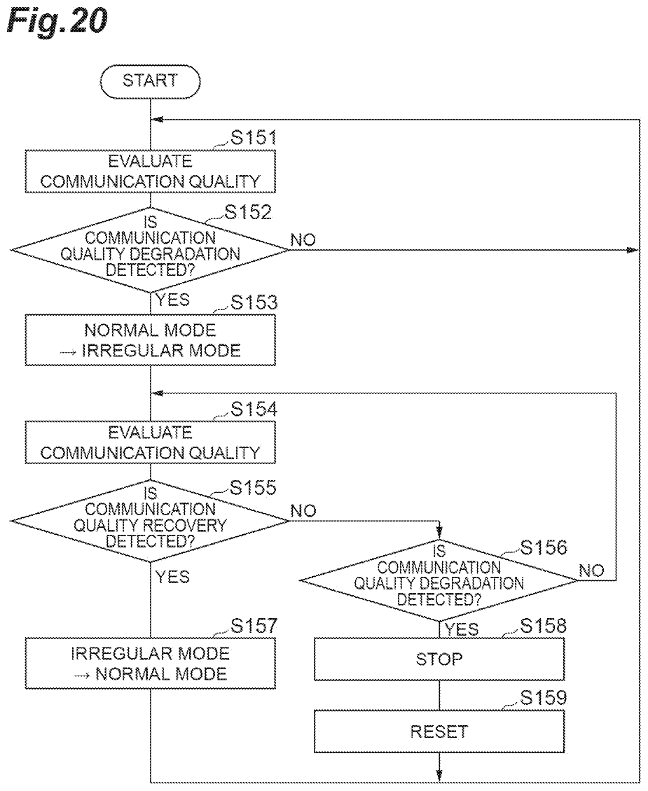

As illustrated in FIG. 20, the control server 100 first executes operations S151 and S152. In the operation S151, the communication monitor 331 evaluates communication quality in the asynchronous slot 522. In the operation S152, the communication monitor 331 checks whether the communication quality in the asynchronous slot 522 has been degraded.

If no degradation in communication quality is detected in the operation S152, the local controller 300 returns the processing to the operation S151. If a degradation in communication quality is detected in the operation S152, the local controller 300 executes an operation S153. In the operation S153, the communication control unit 312 switches the normal mode to the irregular mode. The communication control unit 312 may request the communication control unit 112 to switch from the normal mode to the irregular mode.

Next, the local controller 300 executes operations S154 and S155. In the operation S154, the communication monitor 331 evaluates communication quality in the asynchronous slot 522 and communication quality in the synchronous slot 521. In the operation S155, the communication monitor 331 checks whether communication quality in the asynchronous slot 522 has been recovered.

If no recovery of communication quality is detected in the operation S155, the local controller 300 executes an operation S156. In the operation S156, the communication monitor 331 checks whether the communication quality in the synchronous slot 521 has been degraded. If no degradation in communication quality is detected in the operation S156, the local controller 300 returns the processing to the operation S154.

If the recovery of communication quality is detected in the operation S155, the local controller 300 executes an operation S157. In the operation S157, the communication control unit 312 switches from irregular mode to normal mode. The communication control unit 312 may request the communication control unit 112 to switch from irregular mode to normal mode.

If a degradation in communication quality is detected in the operation S156, the control server 100 executes operations S158 and S159. In the operation S158, the communication control unit 312 interrupts the control of the machine 20 by the controller 111 and stops the movement of the machine 20 when a degradation in communication quality in the synchronous slot 521 is detected by the communication monitor 131. For example, the communication control unit 312 sends the plurality of machines 20 stop requests to the communication control unit 112 if a degradation in communication quality in the synchronous slot 521 is detected by the communication monitor 331. The communication control unit 112 receiving the stopping request interrupts the control of the plurality of machines 20 by the plurality of controllers 111 and stops the plurality of machines 20. In an operation S159, the reset unit 332 requests the wireless communication unit 413 to reset wireless communication after the communication control unit 312 has shut down the plurality of machines 20. The wireless communication unit 413 resets wireless communication with the base station 200 in response to the request from the reset unit 332. For example, the wireless communication unit 413 requests the wireless communication unit 213 to perform the pairing again.

After performing the operation S157 or the operation S159, the local controller 300 returns the processing to the operation S151. The local controller 300 repeats the above procedure.

The communication system 1 according to an aspect of the present disclosure includes: the wireless communication system 2 configured to perform wireless communication by repeating a time division duplex pattern in which the plurality of communication slots 510 are arranged in a time division manner; the application 3 configured to perform cyclic communication using the wireless communication system 2; and the communication control units 112, 312 configured to control the cyclic communication so that at least a part of each of two or more consecutive communication cycles of cyclic communication is performed within one time division duplex pattern of the wireless communication.

The time division duplex pattern may not be suitable for the cyclic communication of the application 3. In contrast, according to the configuration in which the wireless communication system 2 is controlled so that at least a part of each of two or more consecutive communication cycles of cyclic communication is performed within one time division duplex pattern of wireless communication, the arrangement of the communication slot 510 (hereinafter referred to as a “slot arrangement”) in each communication cycle of cyclic communication may be adjusted without changing the time division duplex pattern. Accordingly, wireless communication may readily be applied to various the application 3.

The application 3 may perform cyclic communication in a communication cycle that is an integer fraction of the repetition cycle of the time division duplex pattern. Wireless communication may be applied to the application 3 requiring cyclic communication in a communication cycle shorter than the repetition cycle of the time division duplex pattern.

The communication control units 112, 312 may be configured to control the cyclic communication so that the number of the communication slots 510 used in each of two or more communication cycles is equal to each other. The slot arrangement in each of two or more communication cycles may be more suitably adjusted.

The plurality of communication slots 510 may include the uplink slot 512 of time division duplex, and the communication control units 112, 312 may be configured to control the cyclic communication so that the number of the number of the uplink slots 512 used in each of two or more communication cycles is equal to each other. The slot arrangement in each of two or more communication cycles may be more suitably adjusted.

The plurality of communication slots 510 may further include the downlink slot 511 of time division duplex, and the communication control units 112, 312 may be configured to control the cyclic communication so that the uplink slot 512 is arranged after the downlink slot 511 in each of the two or more communication cycles. In the communication cycle, wireless communication may be applied to the application 3 in which communication by the downlink slot 511 is to precede communication by the uplink slot 512.

The application 3 may be configured to repeatedly perform a communication cycle by the cyclic communication, the communication cycle including reception of command data for controlling an industrial machine and transmission of response data of the industrial machine in accordance with the command data. The slot arrangement may be adjusted to be suitable for control the industrial machine.

The communication control units 112, 312 may be configured to control the cyclic communication so that at least one communication cycle of the two or more communication cycles is performed over two or more consecutive time division duplex patterns of the wireless communication. By combining two or more time division duplex patterns, the slot arrangement may be adjusted with a higher degree of freedom.

The communication control units 112, 312 may be configured to control the cyclic communication so that a first communication cycle performed over two or more time division duplex patterns and a second communication cycle performed within one time division duplex pattern are included in the two or more communication cycles. Both shortening of the communication cycle and adjustment of the slot arrangement in the communication cycle may readily be achieved.

The plurality of communication slots 510 may include the uplink slot 512 and the downlink slot 511 of time division duplex, and the communication control units 112, 312 may control the cyclic communication so that a synchronous communication cycle and an asynchronous communication cycle are included in the two or more communication cycles, an arrangement of the uplink slot 512 and the downlink slot 511 in the synchronous communication cycle matching that in another wireless communication performed in parallel with the wireless communication, the arrangement of the uplink slot 512 and the downlink slot 511 in the asynchronous communication cycle not matching that in the other wireless communication. Communication quality in the synchronous communication cycle may be maintained and continuous degradation of communication quality may be prevented even when communication quality in the asynchronous communication cycle is degraded due to interference.

Communication monitors 131, 331 configured to evaluate communication quality in the asynchronous communication cycle may be further provided. By evaluating the communication quality in the asynchronous communication cycle, the occurrence of a degradation in the communication quality may be quickly detected.

The communication control units 112, 312 may be configured to request the wireless communication system 2 to increase the signal strength of the wireless communication when a degradation of the communication quality in the asynchronous communication cycle is detected by the communication monitors 131, 331. The deterioration of communication quality may readily be eliminated.

The communication control units 112, 312 may be configured to control the cyclic communication so as to lengthen the communication cycle of the cyclic communication so that each of two or more communication cycles becomes the synchronous communication cycle when a degradation of the communication quality in the asynchronous communication cycle is detected by the communication monitors 112, 312. The deterioration of communication quality may readily be eliminated.

The communication monitors 131, 331 may be configured to evaluate the communication quality in the asynchronous communication cycle based on a loss rate of the packet. The communication quality may readily be evaluated.

The communication monitors 131, 331 may evaluate communication quality in the asynchronous communication cycle based on the level of the jitter. The communication quality may readily be evaluated.

The target setting unit 122 configured to set a target arrangement of the downlink slot 511 and the uplink slot 512 based on configuration information of the application 3 may be further provided. The communication control units 112, 312 may be configured to control the cyclic communication so that the arrangement of the downlink slot 511 and the uplink slot 512 in each of the communication control units 112, 312 and two or more communication cycles approximates the target arrangement. The slot arrangement may be flexibly adjusted according to the configuration of the application 3.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A communication system configured to perform wireless communication by repeating a time division duplex pattern having sequential arrangement of communication slots, the communication system comprising a pair of devices configured to:
perform cyclic communication with each other by repeating a communication cycle using the wireless communication; and
control the cyclic communication so that a first part of one time division duplex pattern of the wireless communication is included in one communication cycle of the cyclic communication and a second part of the one time division duplex pattern is included in another communication cycle of the cyclic communication subsequent to the one communication cycle.

2. The communication system according to claim 1, wherein the pair of devices are configured to repeat the communication cycle at a communication interval that is an integer fraction of a repetition interval of the time division duplex pattern.

3. The communication system according to claim 1, wherein the pair of devices are configured to:
receive a timing information associated with a start timing of the time division duplex pattern; and
control a start timing of the communication cycle based on the timing information so that the first part of the one time division duplex pattern is included in the one communication cycle and the second part of the one time division duplex pattern is included in the other communication cycle.

4. The communication system according to claim 1, wherein a first device of the pair of devices is configured to:
receive a timing information associated with a start timing of the time division duplex pattern;
recognize, based on the received timing information, a first timing for transmitting first data to a second device of the pair of devices so that the first part of the one time division duplex pattern is included in the one communication cycle and the second part of the one time division duplex pattern is included in the other communication cycle; and
start transmitting the first data to the second device at the recognized first timing.

5. The system according to claim 4, wherein the second device is configured to:
receive the timing information;
recognize, based on the received timing information, a second timing for transmitting second data to the first device so that the first part of the one time division duplex pattern is included in the one communication cycle and the second part of the one time division duplex pattern is included in the other communication cycle; and
start transmitting the second data to the first device at the recognized second timing.

6. The communication system according to claim 1, wherein the pair of devices are configured to control the cyclic communication so that each of the one communication cycle and the other communication cycle includes an identical number of communication slots of one or more time division duplex patterns of the wireless communication.

7. The communication system according to claim 1, wherein the communication slots include one or more uplink slots of time division duplex, and
wherein the pair of devices are configured to control the cyclic communication so that each of the one communication cycle and the other communication cycle includes an identical number of uplink slots of one or more time division duplex patterns.

8. The communication system according to claim 7, wherein the communication slots further include one or more downlink slots of time division duplex, and
wherein the pair of devices are configured to control the cyclic communication so that the identical number of uplink slots are arranged after at least one downlink slot in each of the one communication cycle and the other communication cycle.

9. The communication system according to claim 1, wherein one of the pair of devices is a controller and another of the pair of devices is an industrial machine controlled by the controller, and
wherein the communication cycle includes:
transmitting, from the controller to the industrial machine using the wireless communication, command data for controlling the industrial machine; and
transmitting, from the industrial machine to the controller using the wireless communication, response data of the industrial machine operated according to the command data.

10. The communication system according to claim 1, wherein the pair of devices are configured to control the cyclic communication so that at least the one communication cycle is performed across two or more consecutive time division duplex patterns of the wireless communication including the one time division duplex pattern.

11. The communication system according to claim 10, wherein the pair of devices are configured to control the cyclic communication so that the other communication cycle is performed within the one time division duplex pattern.

12. The communication system according to claim 1, wherein the communication slots include one or more uplink slots and one or more downlink slots of time division duplex,
wherein the wireless communication is performed in parallel with another wireless communication, the other wireless communication is performed by repeating another time division duplex pattern having another sequential arrangement of one or more uplink slots and one or more downlink slots of time division duplex, and
wherein the pair of devices are configured to control the cyclic communication so that:
the one communication cycle is a synchronous communication cycle having an arrangement of at least one uplink slot and at least one downlink slot that matches the other sequential arrangement; and
the other communication cycle is an asynchronous communication cycle having an arrangement of at least one uplink slot and at least one downlink slot that does not match the other sequential arrangement.

13. The communication system according to claim 12,
wherein the pair of devices are further configured to evaluate communication quality in the asynchronous communication cycle.

14. The communication system according to claim 13,
wherein the pair of devices are configured to increase a signal strength of the wireless communication in response to detecting a degradation of the communication quality in the asynchronous communication cycle.

15. The communication system according to claim 13, wherein the pair of devices are configured to:
repeat the communication cycle at a communication interval;
detect a degradation of the communication quality in the asynchronous communication cycle; and
control the cyclic communication to lengthen, in response to detecting the degradation, the communication interval so that each of the one communication cycle and the other communication cycle becomes the synchronous communication cycle.

16. The communication system according to claim 13, wherein the pair of devices are configured to evaluate the communication quality in the asynchronous communication cycle based on a loss rate of packets.

17. The communication system according to claim 13, wherein the pair of devices are configured to evaluate the communication quality in the asynchronous communication cycle based on a level of jitter.

18. The communication system according to claim 1, wherein the communication slots include one or more uplink slots and one or more downlink slots of time division duplex, and
wherein the pair of devices are further configured to:
set a target arrangement of at least one downlink slot and at least one uplink slot based on configuration of the pair of devices; and
control the cyclic communication to reduce a difference between the target arrangement and an arrangement of at least one downlink slot and at least one uplink slot in each of the one communication cycle and the other communication cycle.

19. Circuitry configured to control cyclic communication performed by repeating a communication cycle using a wireless communication,
wherein the wireless communication is performed by repeating a time division duplex pattern having a sequential arrangement of communication slots, and
wherein the circuitry is configured to control the cyclic communication so that a first part of one time division duplex pattern is included in one communication cycle of the cyclic communication and a second part of the one time division duplex pattern is included in another communication cycle of the cyclic communication subsequent to the one communication cycle.

20. A communication method comprising:
performing cyclic communication between a pair of devices by repeating a communication cycle using a wireless communication, wherein the wireless communication is performed by repeating a time division duplex pattern having sequentially arranged communication slots; and
controlling the cyclic communication so that a first part of one time division duplex pattern is included in one communication cycle of the cyclic communication and a second part of the one time division duplex pattern is included in another communication cycle of the cyclic communication subsequent to the one communication cycle.
